(19) United States
(12) Patent Application Publication
(10) Pub. No.: US 2016/0353506 A1
(43) Pub. Date: Dec. 1, 2016

(54) MULTI-RADIO GATEWAY WITH WIDE AREA NETWORK TUNNELING

(71) Applicant: QUALCOMM Incorporated, San Diego, CA (US)

(72) Inventors: Sandip HomChaudhuri, San Jose, CA (US); Anil Satyanarayana Rao, San Diego, CA (US); Navid Ehsan, San Diego, CA (US); Pradeep Kumar Yenganti, Cupertino, CA (US); Alireza Raissinia, Monte Sereno, CA (US); Vincent Knowles Jones, IV, Redwood City, CA (US)

(21) Appl. No.: 15/094,432

(22) Filed: Apr. 8, 2016

Related U.S. Application Data
(60) Provisional application No. 62/168,448, filed on May 29, 2015.

(51) Int. Cl. H04W 76/02; H04W 76/04; H04W 68/00

(52) U.S. Cl. CPC H04W 76/025; H04W 76/022; H04W 68/00; H04W 76/045; H04W 84/12

(57) ABSTRACT

Methods, systems, and devices are described for wireless communication. A device with multiple radios may establish a wireless local area network (WLAN) connection with a multi-radio gateway (i.e., a multiPHY gateway) and a wide area network (WAN) connection with a base station. The multi-radio device may receive a proxy capability indication from the multi-radio gateway and may transmit connection information relating to the second wireless connection. The multi-radio device may then establish a tunnel to the base station utilizing a proxy entity within the multi-radio gateway and close a physical (PHY) connection of the second wireless connection in order to save power. The multi-radio gateway may receive messages (e.g., paging, broadcast, or multicast messages) from the base station on behalf of the multi-radio device using the proxy entity, and tunnel the messages through to the multi-radio device using the WLAN wireless connection.

### CROSS REFERENCES

The present application for Patent claims priority to U.S. Provisional Patent Application No. 62/168,448 by HomChaudhuri et al., entitled “MultiPHY Gateway with Wide Area Network Tunneling,” filed May 29, 2015, assigned to the assignee hereof, and expressly incorporated by reference herein.

### BACKGROUND

The following relates generally to wireless communication, and more specifically to a multi-radio gateway with wide area network tunneling.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless wide area network (WAN) may be a multiple-access communications system including a number of base stations, each simultaneously supporting communication for multiple communication devices, which may be otherwise known as user equipment (UE).

A wireless local area network (WLAN), such as a wireless fidelity (Wi-Fi) network may include an access point (AP) that may communicate with one or more stations (wireless devices) or mobile devices. The AP may be coupled to a network, such as the Internet, and may enable a mobile device to communicate via the network (or communicate with other devices coupled to the access point).

In some cases a device may be equipped with multiple radios, such as one radio for WAN communications and another radio for WLAN communication. A multi-radio device may consume additional power when both radios are operating, even if one or both radios are in a standby or idle mode. This may deplete the battery power of the device and reduce the time that the device is operational.

### SUMMARY

A device with multiple radios may establish a first wireless connection (e.g., a wireless local area network (WLAN) connection) with a multi-radio gateway (i.e., a multiPHY gateway) and a second wireless connection (e.g., a wide area network (WAN) connection) with a base station. The multi-radio device may receive a proxy capability indication from the multi-radio gateway and may transmit connection information relating to the second wireless connection. The multi-radio device may then establish a tunnel to the base station utilizing a proxy entity within the multi-radio gateway and close a physical (PHY) connection of the second wireless connection in order to save power. The multi-radio gateway may receive messages (e.g., paging, broadcast, or multicast messages) from the base station on behalf of the multi-radio device using the proxy entity, and tunnel the messages through to the multi-radio device using the first wireless connection.

A method of wireless communication is described. The method may include establishing a first wireless connection with a multi-radio gateway and a second wireless connection with a base station, receiving a proxy capability indication from the multi-radio gateway, transmitting connection information to the multi-radio gateway based at least in part on the proxy capability indication, wherein the connection information relates to the second wireless connection, establishing a tunnel to the base station utilizing a proxy entity within the multi-radio gateway, wherein the proxy entity is capable of communicating with the base station based at least in part on the connection information, and closing a PHY connection of the second wireless connection based at least in part on the tunnel.

An apparatus for wireless communication is described. The apparatus may include a connection component for establishing a first wireless connection with a multi-radio gateway and a second wireless connection with a base station, a multi-radio gateway detection component for receiving a proxy capability indication from the multi-radio gateway, a proxy entity context component for transmitting connection information to the multi-radio gateway based at least in part on the proxy capability indication, wherein the connection information relates to the second wireless connection, a tunneling component for establishing a tunnel to the base station utilizing a proxy entity within the multi-radio gateway, wherein the proxy entity is capable of communicating with the base station based at least in part on the connection information, and a power saving component for closing a PHY connection of the second wireless connection based at least in part on the tunnel.

A further apparatus for wireless communication is described. The apparatus may include a processor, memory in electronic communication with the processor, and instructions stored in the memory and operable, when executed by the processor, to cause the apparatus to establish a first wireless connection with a multi-radio gateway and a second wireless connection with a base station, receive a proxy capability indication from the multi-radio gateway, transmit connection information to the multi-radio gateway based at least in part on the proxy capability indication, wherein the connection information relates to the second wireless connection, establish a tunnel to the base station utilizing a proxy entity within the multi-radio gateway, wherein the proxy entity is capable of communicating with the base station based at least in part on the connection information, and close a PHY connection of the second wireless connection based at least in part on the tunnel.

A non-transitory computer-readable medium storing code for wireless communication is described. The code may include instructions executable to establish a first wireless connection with a multi-radio gateway and a second wireless connection with a base station, receive a proxy capability indication from the multi-radio gateway, transmit connection information to the multi-radio gateway based at least in part on the proxy capability indication, wherein the connection information relates to the second wireless connection, establish a tunnel to the base station utilizing a proxy entity within the multi-radio gateway, wherein the proxy entity is capable of communicating with the base station based at least in part on the connection information, and close a PHY connection of the second wireless connection based at least in part on the tunnel.

Some examples of the method, apparatuses, or non-transitory computer-readable medium described herein may further include processes, features, means, or instructions for receiving data related to the second wireless connection via the tunnel after the data is sent from the base station to the proxy entity of the multi-radio gateway. Additionally or alternatively, some examples may include processes, features, means, or instructions for transmitting a proxy request message to the multi-radio gateway, wherein the proxy capability indication is received in response to the proxy request message.

In some examples of the method, apparatuses, or non-transitory computer-readable medium described herein, closing the PHY connection comprises powering down at least one component of a radio associated with the second wireless connection. Additionally or alternatively, in some examples the proxy capability indication is received in a beacon message via the first wireless connection.

In some examples of the method, apparatuses, or non-transitory computer-readable medium described herein, the first wireless connection comprises a wireless local area network connection, and the second wireless connection comprises a wide area network connection. Additionally or alternatively, some examples may include processes, features, means, or instructions for receiving a paging message from the base station via the tunnel.

Some examples of the method, apparatuses, or non-transitory computer-readable medium described herein may further include processes, features, means, or instructions for terminating the tunnel based at least in part on the paging message. Additionally or alternatively, some examples may include processes, features, means, or instructions for reestablishing the PHY connection based at least in part on the paging message.

In some examples of the method, apparatuses, or non-transitory computer-readable medium described herein, the paging message is received in a beacon via the first wireless connection. Additionally or alternatively, in some examples the paging message is received in an vendor specific action frame with prioritized interframe space (PIFS) access.

Some examples of the method, apparatuses, or non-transitory computer-readable medium described herein may further include processes, features, means, or instructions for receiving a message from the multi-radio gateway, wherein the message is a broadcast or multicast message from the base station. Additionally or alternatively, in some examples the message is received in a DTIM broadcast or multicast message via the first wireless connection.

In some examples of the method, apparatuses, or non-transitory computer-readable medium described herein, the message is received in a unicast packet via the first wireless connection. Additionally or alternatively, some examples may include processes, features, means, or instructions for receiving context information for the second wireless connection from the multi-radio gateway, closing the tunnel based at least in part on the received context information, and resuming the PHY connection based at least in part on the received context information.

Some examples of the method, apparatuses, or non-transitory computer-readable medium described herein may further include processes, features, means, or instructions for transmitting a tunnel disconnect message to the multi-radio gateway, wherein the context information is received in response to the tunnel disconnect message. Additionally or alternatively, some examples may include processes, features, means, or instructions for performing an abbreviated timing alignment procedure based at least in part on the context information, wherein resuming the PHY connection is based at least in part on the abbreviated timing alignment procedure.

In some examples of the method, apparatuses, or non-transitory computer-readable medium described herein, the context information is received based at least in part on a multi-radio gateway initiated disconnect procedure. Additionally or alternatively, some examples may include processes, features, means, or instructions for reestablishing the second wireless connection with a second base station, and performing an area update procedure based at least in part on the reestablished second wireless connection.

Some examples of the method, apparatuses, or non-transitory computer-readable medium described herein may further include processes, features, means, or instructions for receiving a reconnection request for the second wireless connection from the multi-radio gateway, wherein reestablishing the second wireless connection and performing the area update procedure are based at least in part on the reconnection request. Additionally or alternatively, some examples may include processes, features, means, or instructions for moving to a location outside a region of the base station, and receiving one or more connection parameters from the multi-radio gateway based at least in part on moving to the location, wherein reestablishing the second wireless connection and performing the area update procedure are based at least in part on the one or more connection parameters.

In some examples of the method, apparatuses, or non-transitory computer-readable medium described herein, the region of the base station comprises a tracking area, a location area, or a routing area of the base station. Additionally or alternatively, some examples may include processes, features, means, or instructions for moving to a location outside a basic service set (BSS) associated with an AP of the multi-radio gateway, and performing a cell acquisition procedure for the second base station based at least in part on moving to the location.

A method of wireless communication is described. The method may include establishing a first wireless connection with a multi-radio gateway, receiving an indication that the multi-radio gateway is capable of communicating via a second wireless connection, wherein the second wireless connection consumes less power than the first wireless connection, establishing the second wireless connection with the multi-radio gateway based at least in part on the indication, closing a PHY connection of the first wireless connection based at least in part on the second wireless connection, and receiving a message from the multi-radio gateway via the second wireless connection.

An apparatus for wireless communication is described. The apparatus may include a connection component for establishing a first wireless connection with a multi-radio gateway, a multi-radio gateway detection component for receiving an indication that the multi-radio gateway is capable of communicating via a second wireless connection, wherein the second wireless connection consumes less power than the first wireless connection, a connection component for establishing the second wireless connection with the multi-radio gateway based at least in part on the indication, a power saving component for closing a PHY connection of the first wireless connection based at least in part on the second wireless connection, and a receiver for receiving a message from the multi-radio gateway via the second wireless connection.

A further apparatus for wireless communication is described. The apparatus may include a processor, memory in electronic communication with the processor, and instructions stored in the memory and operable, when executed by the processor, to cause the apparatus to establish a first wireless connection with a multi-radio gateway, receive an indication that the multi-radio gateway is capable of communicating via a second wireless connection, wherein the second wireless connection consumes less power than the first wireless connection, establish the second wireless connection with the multi-radio gateway based at least in part on the indication, close a PHY connection of the first wireless connection based at least in part on the second wireless connection, and receive a message from the multi-radio gateway via the second wireless connection.

A non-transitory computer-readable medium storing code for wireless communication is described. The code may include instructions executable to establish a first wireless connection with a multi-radio gateway, receive an indication that the multi-radio gateway is capable of communicating via a second wireless connection, wherein the second wireless connection consumes less power than the first wireless connection, establish the second wireless connection with the multi-radio gateway based at least in part on the indication, close a PHY connection of the first wireless connection based at least in part on the second wireless connection, and receive a message from the multi-radio gateway via the second wireless connection.

In some examples of the method, apparatuses, or non-transitory computer-readable medium described herein, the first wireless connection comprises a wide area network connection and the second wireless connection comprises a local area network connection. Additionally or alternatively, some examples may include processes, features, means, or instructions for entering an idle mode for the first wireless connection, wherein establishing the second wireless connection is based at least in part on entering the idle mode.

In some examples of the method, apparatuses, or non-transitory computer-readable medium described herein, the message is a paging message, a control message, a broadcast message, or a multicast message, and reopening the PHY connection is based at least in part on the message. Additionally or alternatively, in some examples closing the PHY connection comprises powering down at least one component of a radio associated with the first wireless connection.

A method of wireless communication is described. The method may include transmitting a proxy capability indication to a multiradio device via a first wireless connection, receiving connection information from the multiradio device in response to the proxy capability indication, establishing a proxy entity for a second wireless connection associated with the multiradio device based at least in part on the connection information, receiving a message for the multiradio device via the second wireless connection, and tunneling the message to the multiradio device via the first wireless connection.

An apparatus for wireless communication is described. The apparatus may include a proxy capability indication component for transmitting a proxy capability indication to a multiradio device via a first wireless connection, a connection information component for receiving connection information from the multiradio device in response to the proxy capability indication, a proxy entity component for establishing a proxy entity for a second wireless connection associated with the multiradio device based at least in part on the connection information, a receiver for receiving a message for the multiradio device via the second wireless connection, and a gateway (GW) tunneling component for tunneling the message to the multiradio device via the first wireless connection.

A further apparatus for wireless communication is described. The apparatus may include a processor, memory in electronic communication with the processor, and instructions stored in the memory and operable, when executed by the processor, to cause the apparatus to transmit a proxy capability indication to a multiradio device via a first wireless connection, receive connection information from the multiradio device in response to the proxy capability indication, establish a proxy entity for a second wireless connection associated with the multiradio device based at least in part on the connection information, receive a message for the multiradio device via the second wireless connection, and tunnel the message to the multiradio device via the first wireless connection.

A non-transitory computer-readable medium storing code for wireless communication is described. The code may include instructions executable to transmit a proxy capability indication to a multiradio device via a first wireless connection, receive connection information from the multiradio device in response to the proxy capability indication, establish a proxy entity for a second wireless connection associated with the multiradio device based at least in part on the connection information, receive a message for the multiradio device via the second wireless connection, and tunnel the message to the multiradio device via the first wireless connection.

In some examples of the method, apparatuses, or non-transitory computer-readable medium described herein, the proxy capability indication is transmitted in a beacon message via the first wireless connection. Additionally or alternatively, some examples may include processes, features, means, or instructions for receiving a proxy request message from the multiradio device via the first wireless connection, wherein the proxy capability indication is transmitted in response to the proxy request message.

In some examples of the method, apparatuses, or non-transitory computer-readable medium described herein, the first wireless connection comprises a wireless local area network connection, and the second wireless connection comprises a wide area network connection. Additionally or alternatively, in some examples the message comprises a paging message.

Some examples of the method, apparatuses, or non-transitory computer-readable medium described herein may further include processes, features, means, or instructions for terminating the tunnel based at least in part on the paging message. Additionally or alternatively, in some examples the paging message is transmitted via a beacon message.

In some examples of the method, apparatuses, or non-transitory computer-readable medium described herein, the paging message is transmitted in a vendor specific action frame with prioritized interframe space (PIFS) access. Additionally or alternatively, some examples may include processes, features, means, or instructions for identifying a paging group of the multiradio device, wherein the message is tunneled based at least in part on the paging group.

In some examples of the method, apparatuses, or non-transitory computer-readable medium described herein, the message is a broadcast or multicast message.

Additionally or alternatively, in some examples the message is tunneled using a DTIM broadcast or multicast message of the first wireless connection.

In some examples of the method, apparatuses, or non-transitory computer-readable medium described herein, the message is tunneled using a unicast message of the first wireless connection. Additionally or alternatively, some examples may include processes, features, means, or instructions for establishing an additional local connection with each of one or more additional multiradio devices, establishing an additional proxy entity for each of the one or more additional multiradio devices, and tunneling data from the base station to the one or more additional multiradio devices via the additional proxy entities and the additional local connections.

Some examples of the method, apparatuses, or non-transitory computer-readable medium described herein may further include processes, features, means, or instructions for receiving uplink (UL) data from a plurality of the one or more additional multiradio devices, and transmitting the UL data to the base station using different frequency resources for each of the plurality of the one or more additional multiradio devices. Additionally or alternatively, some examples may include processes, features, means, or instructions for identifying a tunnel disconnect condition, transferring context information for the proxy entity to the multiradio device based at least in part on the tunnel disconnect condition, and terminating the proxy entity based at least in part on the tunnel disconnect condition.

In some examples of the method, apparatuses, or non-transitory computer-readable medium described herein, identifying the tunnel disconnect condition comprises receiving a tunnel disconnect message from the multiradio device. Additionally or alternatively, in some examples identifying the tunnel disconnect condition comprises receiving a paging message for the multiradio device from the base station.

Some examples of the method, apparatuses, or non-transitory computer-readable medium described herein may further include processes, features, means, or instructions for identifying an area update trigger condition. Additionally or alternatively, some examples may include processes, features, means, or instructions for transmitting a reconnection request to the multiradio device based at least in part on the identified area update trigger condition.

Some examples of the method, apparatuses, or non-transitory computer-readable medium described herein may further include processes, features, means, or instructions for performing an area update procedure for the second wireless connection based at least in part on the identified area update trigger condition. Additionally or alternatively, in some examples the area update trigger condition is related to a tracking area update, a location area update, or a routing area update.

A method of wireless communication is described. The method may include establishing a first wireless connection with a multiradio device, determining that the multiradio device is capable of communicating via a second wireless connection, establishing a second wireless connection with the multiradio device based at least in part on the determination, refraining from sending data over the first wireless connection based at least in part on the second wireless connection, receiving a message for the multiradio device from a core network entity, and transmitting the message to the multiradio device via the second wireless connection.

An apparatus for wireless communication is described. The apparatus may include a connection component for establishing a first wireless connection with a multiradio device, a multiradio detection component for determining that the multiradio device is capable of communicating via a second wireless connection, a connection component for establishing a second wireless connection with the multiradio device based at least in part on the determination, a tunneling component for refraining from sending data over the first wireless connection based at least in part on the second wireless connection, a receiver for receiving a message for the multiradio device from a core network entity, and a tunneling component for transmitting the message to the multiradio device via the second wireless connection.

A further apparatus for wireless communication is described. The apparatus may include a processor, memory in electronic communication with the processor, and instructions stored in the memory and operable, when executed by the processor, to cause the apparatus to establish a first wireless connection with a multiradio device, determine that the multiradio device is capable of communicating via a second wireless connection, establish a second wireless connection with the multiradio device based at least in part on the determination, refrain from sending data over the first wireless connection based at least in part on the second wireless connection, receive a message for the multiradio device from a core network entity, and transmit the message to the multiradio device via the second wireless connection.

A non-transitory computer-readable medium storing code for wireless communication is described. The code may include instructions executable to establish a first wireless connection with a multiradio device, determine that the multiradio device is capable of communicating via a second wireless connection, establish a second wireless connection with the multiradio device based at least in part on the determination, refrain from sending data over the first wireless connection based at least in part on the second wireless connection, receive a message for the multiradio device from a core network entity, and transmit the message to the multiradio device via the second wireless connection.

In some examples of the method, apparatuses, or non-transitory computer-readable medium described herein, the first wireless connection comprises a wide area network connection and the second wireless connection comprises a local area network connection. Additionally or alternatively, in some examples the message is a paging message, a control message, a broadcast message, or a multicast message.

Some examples of the method, apparatuses, or non-transitory computer-readable medium described herein may further include processes, features, means, or instructions for resuming communications over the first wireless connection based at least in part on the message.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If the first reference label is used in the specification, the description is applicable to any one of the similar components having the same first reference label irrespective of the second reference label.

FIG. 1 illustrates an example of a wireless communications system that supports a multi-radio gateway with wide area network tunneling in accordance with various aspects of the present disclosure;

FIG. 2 illustrates an example of a wireless communications subsystem that supports a multi-radio gateway with wide area network tunneling in accordance with various aspects of the present disclosure;

FIG. 3 illustrates an example of a small cell multi-radio gateway system with wide area network tunneling in accordance with various aspects of the present disclosure;

FIG. 4 illustrates an example of a process flow that supports a multi-radio gateway with wide area network tunneling in accordance with various aspects of the present disclosure;

FIGS. 5-7 show block diagrams of a wireless device that supports a multi-radio gateway with wide area network tunneling in accordance with various aspects of the present disclosure;

FIG. 8 illustrates a block diagram of a system including a user equipment (UE) that supports a multi-radio gateway with wide area network tunneling in accordance with various aspects of the present disclosure;

FIGS. 9-11 show block diagrams of a wireless device that supports a multi-radio gateway with wide area network tunneling in accordance with various aspects of the present disclosure;

FIG. 12 illustrates a block diagram of a system including a base station that supports a multi-radio gateway with wide area network tunneling in accordance with various aspects of the present disclosure; and

FIGS. 13-24 illustrate methods for a multi-radio gateway with wide area network tunneling in accordance with various aspects of the present disclosure.

### DETAILED DESCRIPTION

Some wireless devices may have multiple radios supporting communications on multiple radio access technologies (RATs) (e.g., wireless local area network (WLAN) RATs and wide area network (WAN) RATs). A device that contains both WLAN and WAN personas (or multiple personas for other RATs) may be called a multi-radio device. Devices that communicate over both multiple RATs may consume extra power even when operating in standby mode. Although some of the description herein is provided in the context of multi-radio device housing a WAN radio together with a WLAN radio, the disclosure also applies to devices supporting other RATs.

A multi-radio device may involve a regular WLAN hardware modem and WLAN station (STA) software that allows WAN tunneling for the collocated user equipment (UE). It may also include a UE WAN hardware modem and new UE WAN software. In one example, the UE WAN conforms to the LTE standard. In this setting, the LTE Stack may be able to disconnect the physical layer of associated hardware.

One aspect of the present disclosure also involves a multi-radio gateway that houses both a WLAN AP and a Flexible WAN Transceiver. The multi-radio gateway virtualizes multiple remote UE personas and serves as a proxy for them in communication with a base station. For example, the multi-radio gateway may run a complete WAN stack in which multiple user equipments (UEs) are virtualized under the same physical WAN modem. Thus, it may act as a WAN tunnel for an arbitrary number of UEs that connect to it. It uses WAN protocol in its DL to communicate to the tunneled UEs using WAN access rules. In some examples, the multi-radio gateway may have WAN gateways to connect to multiple base stations concurrently, across a single or multiple WAN technologies.

In some examples, a multi-radio gateway provides the capability for UEs to offload paging. First, the multi-radio gateway announces the proxy UE capability (e.g., in its beacon or via a vendor information element (VIE)). Second, the device triggers the setup of a tunneled WAN connection of the WLAN STA/AP interface. It exchanges control plane information with the multi-radio gateway over the WAN Link. A UE persona may be created inside the multi-radio gateway, and the multi-radio gateway virtualizes this connection with the base station. This virtualization may be transparent to the base station. The multi-radio device may then tear down the WAN radio physical link with the base station (although it may maintain the RRC and NAS levels).

In some cases, while the remote UE operates on a tunneled WAN link it may not actively manage the link with a base station. That is, the multi-radio gateway may be ultimately responsible for connection management with the base station. Furthermore, some idle mode procedures are local to the device and may not require interaction with the base station. The multi-radio gateway may perform these procedures for itself and does not need have them virtualized across the proxy UEs.

Another aspect of the disclosure involves the multi-radio gateway serving as a paging hot-spot by maintaining a proxy UE 115 for each remote UE. The proxy UE 115 may be responsible for monitoring the WAN for paging requests directed to the remote UE. The proxy UE 115 looks for the specific paging group associated with each remote UE in the DL Paging channel of the base station. It receives Broadcast, Multicast, and Paging Messages and forwards them to the remote UE. When the proxy UE 115 detects a Paging Message, it transfers the message over the Tunneled WAN link to the remote UE. Once the message is delivered, and the remote UE successfully sets up the call, the tunneled connection may be torn down.

In some examples, the functionality of the multi-radio gateway may be scaled to devices with smaller form factors, such as smartphones, that have a single multi-radio gateway and cannot virtualize a large number of remote UE contexts. In another example, a small cell such as a femtocell could be augmented to act as a multi-radio gateway. In another example, the multi-radio gateway can include separate antenna chains for simultaneous transmission and reception over disparate frequency bands, as in Frequency Division Duplex (FDD) LTE.

Aspects of the disclosure are initially described in the context of a wireless communication system. Specific examples are then described for offloading paging information. These and other aspects of the disclosure are further illustrated by and described with reference to apparatus diagrams, system diagrams, and flowcharts that relate to a multi-radio gateway with wide area network tunneling.

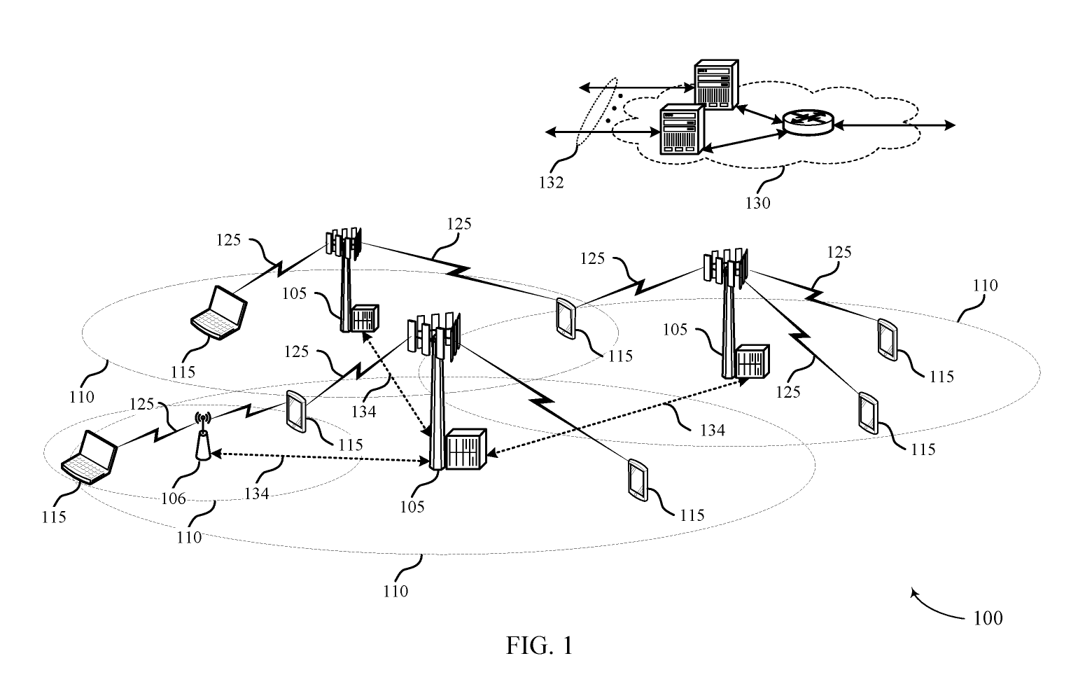

FIG. 1 illustrates an example of a wireless communications system 100 in accordance with various aspects of the present disclosure. The wireless communications system 100 includes base stations 105, user equipment (UEs) 115, and a core network 130. In some examples, the wireless communications system 100 may be a Long Term Evolution (LTE)/LTE-advanced (LTE-a) network. In some examples wireless communications system 100 may also include a local communications network such as a wireless local area network (WLAN). The local communications network may utilize one or more access points (APs) 106, which may be connected either wirelessly or via a wired connection to one or more base stations 105. In some cases, a UE 115 may be collocated (i.e., within the same mobile device) with a station (STA) used for connecting to the local communications network AP 106.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal, a handset, a user agent, a client, or some other suitable terminology. A UE 115 may also be a cellular phone, a wireless modem, a handheld device, a personal computer, a tablet, a personal electronic device, a machine type communication (MTC) device or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

a UE 115 may enter an idle mode and periodically wake up to receive paging messages. In some cases, a UE 115 in idle mode may be assigned a paging radio network temporary identity (P-RNTI). If the serving gateway (S-GW) receives data for the UE 115, it may notify the mobility management entity (MME), which may send a paging message to every base station 105 within an area known as a tracking area. Each base station 105 within the tracking area may send a paging message with the P-RNTI. Thus, the UE may remain in idle without updating the MME until it leaves the tracking area. According to the present disclosure, a multi-radio device housing a UE 115 may establish a local connection and use the local connection to receive paging messages. In this case, the multi-radio device may power down some components of the radio used for connecting with a wide area network of wireless communications system 100.

In some cases, wireless communications system 100 may utilize one or more enhanced component carriers (eCCs). An enhanced component carrier (eCC) may be characterized by one or more features including: flexible bandwidth, different transmission time intervals (TTIs), and modified control channel configuration. In some cases, an eCC may be associated with a carrier aggregation (CA) configuration or a dual connectivity configuration (e.g., when multiple serving cells have a suboptimal backhaul link). An eCC may also be configured for use in unlicensed spectrum or shared spectrum (e.g., where more than one operator may be licensed to use the spectrum). An eCC characterized by flexible bandwidth may include one or more segments that may be utilized by UEs 115 that are not capable of monitoring the whole bandwidth or prefer to use a limited bandwidth (e.g., to conserve power).

In some cases, an eCC may utilize a different TTI length than other component carriers (CCs), which may include use of a reduced or variable symbol duration as compared with TTIs of the other CCs. The symbol duration may remain the same, in some cases, but each symbol may represent a distinct TTI. In some examples, an eCC may include multiple hierarchical layers associated with the different TTI lengths. For example, TTIs at one hierarchical layer may correspond to uniform 1 ms subframes, whereas in a second layer, variable length TTIs may correspond to bursts of short duration symbol periods. In some cases, a shorter symbol duration may also be associated with increased subcarrier spacing. In conjunction with the reduced TTI length, an eCC may utilize dynamic time division duplex (TDD) operation (i.e., it may switch from downlink (DL) to uplink (UL) operation for short bursts according to dynamic conditions.)

Flexible bandwidth and variable TTIs may be associated with a modified control channel configuration (e.g., an eCC may utilize an enhanced physical downlink control channel (ePDCCH) for DL control information). For example, one or more control channels of an eCC may utilize frequency-division multiplexing (FDM) scheduling to accommodate flexible bandwidth use. Other control channel modifications include the use of additional control channels (e.g., for evolved multimedia broadcast multicast service (eMBMS) scheduling, or to indicate the length of variable length UL and DL bursts), or control channels transmitted at different intervals. An eCC may also include modified or additional hybrid automatic repeat request (HARM) related control information.

A device with multiple radios may establish a first wireless connection (e.g., a wireless local area network (WLAN) connection) with a multi-radio gateway (i.e., a multiPHY gateway) and a second wireless connection (e.g., a wide area network (WAN) connection) with a base station. The multi-radio device may receive a proxy capability indication from the multi-radio gateway and may transmit connection information relating to the second wireless connection. The multi-radio device may then establish a tunnel to the base station utilizing a proxy entity within the multi-radio gateway and close a physical (PHY) connection of the second wireless connection in order to save power. The multi-radio gateway may receive messages (e.g., paging, broadcast, or multicast messages) from the base station on behalf of the multi-radio device using the proxy entity, and tunnel the messages through to the multi-radio device using the first wireless connection.

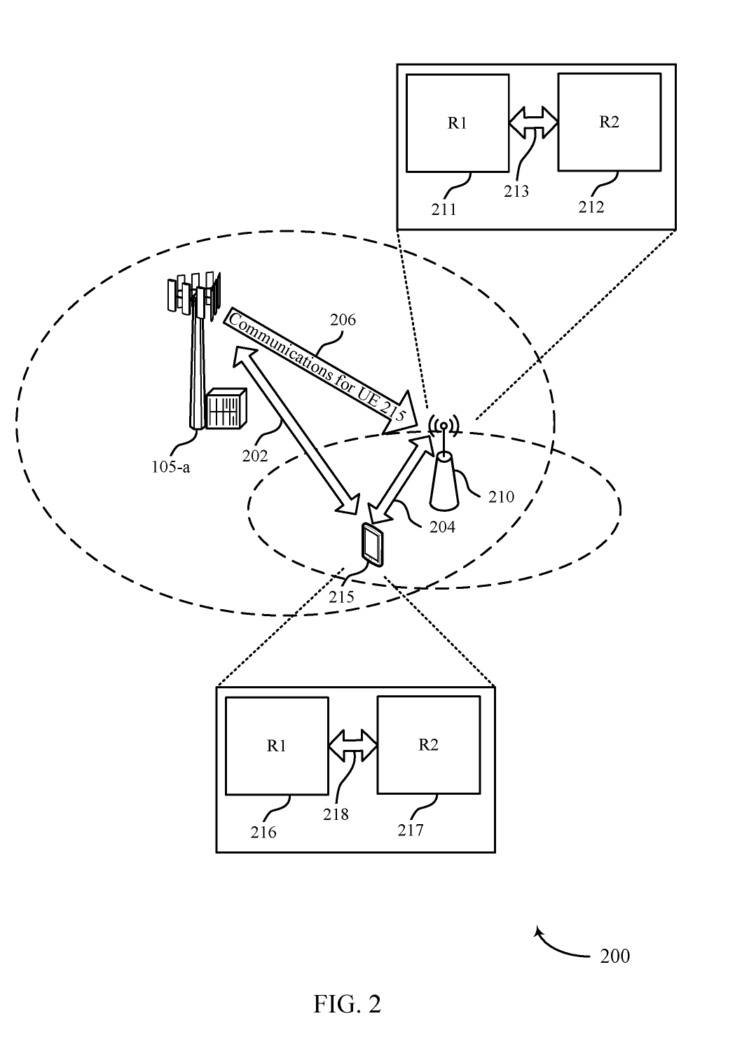

FIG. 2 illustrates an example of a wireless communications system 200 for a multi-radio gateway with wide area network tunneling in accordance with various aspects of the present disclosure. Wireless communications system 200 may include a base station 105-a which may be examples of a UE 115 base station 105 described with reference to FIG. 1. Wireless communications system 200 may also include multi-radio device 215 and multi-radio gateway 210.

Multi-radio device 215 may include a first radio 216 and a second radio 217 connected by a bridge 218. Wireless communications system 200 is described using an example of a device with a WAN radio and a WLAN radio, but other combinations are possible for both multi-radio device 215 and multi-radio gateway 210). For example, the first radio may support a WLAN STA whereas the second radio may support a WAN remote UE 115. WAN and WLAN are two wireless protocols than may adhere to standards (i.e., 3GPP and IEEE) with limited commonality. Interaction over each protocol may involve an enabled persona. A UE persona may cater to the WAN protocol, and the STA persona may cater to the WLAN protocol. Multi-radio device 215 may communicate with base station 105-a via WAN connection 202 and with multi-radio gateway 210 via WLAN connection 204.

Multi-radio device 215 may consume extra power even when operating in standby mode. For instance, the typical standby mode power of standalone LTE UE may be 2 to 4 mA. The typical standby mode power of standalone WLAN STA may be 1.4 to 1.7 mA. This may results in a total power consumption of, for example, 3.4 to 5.7 mA. Additional power consumption may occur, for instance, whenever multi-radio device 215 is concurrently connected to both a WAN macro-cell and WLAN micro-cell. Multi-radio device 215 involves a regular WLAN hardware modem and WLAN STA software that allows WAN tunneling of the collocated UE 115. It may also include a UE WAN hardware modem and new UE WAN software. In one example, the UE WAN conforms to the LTE standard. In this setting, the LTE Stack may be able to disconnect the physical layer (L1) of associated hardware, while retaining RRC and Non-Access Stratum (NAS) layers to maintain connection to the base station through a proxy UE 115.

Multi-radio gateway 210 may include a first radio 211 and a second radio 212 connected by bridge 213. For example, multi-radio gateway 210 may house both a WLAN AP 106 and a Flexible WAN Transceiver supporting a proxy UE 115. That is, multi-radio gateway 210 may virtualize multiple remote UE personas and serves as a proxy for them in communication with base station 105-a via proxy connection 206. In some cases, proxy connection 206 is strictly a DL proxy, and may be invisible to base station 105-a. In other cases, proxy connection 206 is a two-way connection. The WLAN Access Point component may include WLAN modem hardware and new WLAN AP software solution. The multi-radio gateway 210 provides the core of a proxy UE component. It may include regular UE modem hardware and a new UE software solution. A virtualized WAN (e.g., LTE) software stack allows multiple UE personae to run atop a single WAN modem. In addition to these two discrete components, multi-radio gateway 210 also contains a WAN-WLAN Bridge than helps tunnel messages between the two protocols.

The multi-radio gateway 210 component has the following characteristics. It runs a complete WAN stack in which multiple UEs are virtualized under the same physical WAN modem. It acts as a WAN tunnel for an arbitrary number of UEs that connect to it. It uses WAN protocol in its DL, to communicate to the tunneled UEs using WAN access rules. It is potentially Always ON. It has the capability of decoding every sub-frame in every DL frame across the entire carrier bandwidth from base station 105-a and has the ability to transmit in every UL frame across the entire carrier bandwidth. In some examples, multi-radio gateway 210 may have WAN radios/entities to connect to multiple base stations concurrently, across a single or multiple WAN technologies (e.g. MultiSIM).

When a device is camped under both a WLAN Access Point (AP) and a WAN base station 105, it may be better for the AP to handle both DL and UL. This frees up WAN spectrum and permits faster download because WLAN bandwidth may be larger than WAN bandwidth. Existing carrier aggregation techniques, such as Radio Link Control (RLC) and Packet Data Convergence Protocol (PDCP) aggregation, address the active mode bandwidth offload requirement. However these solutions do not provide any power efficiency because they maintain both the WAN and WLAN links. This may be appropriate because the multi-radio device must be able to receive both a Page Message (PM) on the WAN link and a Beacon Message (BM) over the WLAN link. RLC/PDCP aggregation may be also extremely invasive across the Core Network, backhaul and BS/AP interfaces, and this may involve collaboration among many parties including network vendors, device makers, and access point vendors. The present disclosure addresses the power efficiency problem in a modular fashion that does not require changes to the Core Network or infrastructure.

The following section provides a description of one aspect of the disclosure in which multi-radio gateway 210 provides the capability for UEs to offload paging. This capability involves using a WAN component to support WAN connections for UE devices. In principle, multi-radio gateway 210 can proxy for any of the WAN modems (2G/GSM, 3G/UMTS or 4G/LTE), although LTE may be chosen to explain the idea. The multi-radio gateway 210 may be configured to support a differing number of UEs. Two factors influence this quantity. In particular, the number of proxy UE 115 instances govern the number of unique WAN connections that are available to multi-radio gateway 210. Further, each multi-radio gateway 210 may have a capacity that determines the number of UEs that can be provided tunneled WAN access.

The basic functionality proceeds through a series of steps. First, multi-radio gateway 210 announces the proxy UE capability in its beacon via a Vendor IE (VIE). The VIE also provides various Cell identification details that are relevant to multi-radio gateway 210 connection such as Cell-ID, Evolved Absolute Radio-Frequency Channel Number (E-ARFCN), Tracking Area, Location Area, and Routing Area. This information helps multi-radio devices to decide if it can take advantage of the tunneling by verifying, for instance, whether remote UE 115 may be camped on the same base station as multi-radio gateway 210.

Second the device triggers the setup of a tunneled WAN connection of the WLAN STA/AP interface. It exchanges control plane information with multi-radio gateway 210 over the WAN Link. Control plane parameters may include, but are not limited to, UE/Paging Group, Temporary Mobile Subscriber Identity (TMSI), paging Radio Network Temporary Identifier (P-RNTI), Random Access RNTI (RA-RNTI), System Information RNTI (SI-RNTI). A UE persona may be created inside multi-radio gateway 210, and multi-radio gateway 210 virtualizes this connection with base station 105-a. This virtualization may be transparent to base station 105-a.

After connection, the Device tears down the WAN radio/model L1 physical link with base station 105-a while maintaining the RRC and NAS levels. This final step may support seamless connectivity of WAN and WLAN while only utilizing power from the WLAN modem. For example, in some cases disabling the WAN radio/L1 physical link could reduce the overall standby power from 3.4-5.7 mA to 1.4-1.7 m, although other results are possible.

In one aspect of the disclosure, the tunneled connection may be maintained by performing a number of connection management procedures. While the remote UE 115 operates on a tunneled WAN link, it does not actively manage the link with base station. The multi-radio gateway 210 may be ultimately responsible for connection management with base station. The remote UE 115 continues to remain in the tunneled WAN link as long as it is within the basic service set (BSS) of an AP 106 inside multi-radio gateway 210. The basic link sustenance activities demanded by WAN protocol are satisfied by the proxy UE context entirely.

Some idle mode procedures are local to the device and do not require interaction with base station 105-a. Examples include time-drift update which may be an aspect of the L1/Modem hardware, and background scan. The multi-radio gateway 210 performs these procedures for itself and does not need have them virtualized across the proxy UEs. The procedures of Tracking, Location, and Routing Area Updates (TAU, LAU, RAU) are not relevant if multi-radio gateway 210 is stationary. In the case of a mobile multi-radio gateway 210 two examples are considered. In one example, the proxy UE 115 notifies the remote UE 115 to wake up and re-connect with the new base station. The remote UE 115 connects directly, performs the TAU, and, once settled, reconstructs the tunnel with multi-radio gateway 210. In another example, the proxy UE 115 performs the TAU procedure on behalf of the remote UE 115 using appropriate session parameters that have been passed from the remote UE 115 to multi-radio gateway 210 during the setup procedure.

The tunneled connection can be torn down by the remote UE 115 or by the proxy UE 115. When torn down by remote UE 115, it may be an explicit de-registration from base station 105-a, visible to base station 105-a and the Core Network. When torn down by the proxy UE 115, it may be a localized shut down inside multi-radio gateway 210 and not known to base station or Core Network.

Aspects of the present disclosure involve different cases of tearing down the tunneled connection. In the case of a mobile originated call from the remote UE 115, remote UE 115 sends a disconnect message over the WLAN link to the AP. This message may be bridged to the proxy UE 115 context and consumed. The proxy UE 115 transfers the current context (cell-ID etc.) to the remote UE 115 over the WLAN Link, using the WAN/WLAN bridge software. The remote UE 115 optimizes channel acquisition by bypassing full E-ARFCN scan and aligns against the frame timing. The proxy UE 115 tears down the connection and frees up the context within multi-radio gateway 210. The remote UE 115 places the mobile originated call using standard Random Access Channel (RACH) procedure. At the end of the call, the remote UE 115 reacquires the WAN signal via cell selection procedures. Once camped, if still in vicinity of the multi-radio AP, the UE will re-execute the connection establishment procedures described above.

The case of a mobile terminated call from base station 105-a may be similar to case of a mobile originated call from remote UE 115. The remote UE 115 reconnects to base station 105-a after receiving a Paging Message and signals a successful call setup to proxy UE 115. The proxy UE 115 frees the context within multi-radio gateway 210

In the case of a WLAN STA or AP initiated disconnect, the WLAN STA disconnects from the WLAN AP inside multi-radio gateway 210, and the AP software bridges this information to proxy UE 115. The proxy UE 115 shares the UE connection context information with the remote UE 115 as part of the tear down procedure. The WLAN STA transmits the connection context information to the remote UE 115, which then reacquires base station 105-a. The WLAN STA and the proxy UE 115 then tear down their respective connections.

In the case in which the WLAN STA goes out of range of the AP BSS, the WLAN STA will inform the remote UE 115 context to re-acquire the cell. The remote UE 115 has not received the context from the proxy UE 115, so this leads to a complete cell acquisition procedure at the remote UE 115. Meanwhile, the WAN AP detects a Heart Beat Failure on the WLAN link and disconnects the WLAN STA. The WAN AP bridges a disconnect notification to the proxy UE 115 to tear down the WAN connection and free the context within multi-radio gateway 210.

In the case of a cell reselection by the proxy UE 115 when TAU/LAU/RAU is not offloaded, the proxy UE 115 informs the remote UE 115 about the change in its tracking, location, or routing area. The proxy UE 115 furnishes the connection parameters of the new base station over the WAN link and frees the context within multi-radio gateway 210. The remote UE 115 connects to the new base station and performs the TAU/RAU/LAU itself. After TAU/RAU/LAU, the remote UE 115 may re-initiate the tunnel if it finds the new base station it is connected to is compatible with one or more proxy UEs 115 instances in multi-radio gateway 210.

Another aspect of the disclosure involves multi-radio gateway 210 serves as a paging hot-spot by maintaining a proxy UE 115 for each remote UE 115. The proxy UE 115 may be responsible for monitoring the WAN for paging requests directed to the remote UE 115. The proxy UE 115 looks for the specific paging group associated with each remote UE 115 in the DL Paging channel of base station 105-a. It receives Broadcast, Multicast, and Paging Messages and forwards them to the remote UE 115. When the proxy UE 115 detects a Paging Message, it transfers the message over the Tunneled WAN link to the remote UE 115. Once the message is delivered, and the remote UE 115 successfully sets up the call, the tunneled connection may be torn down according to the mobile terminated procedure described above.

In another example, the delivery of the Paging Message over a WLAN tunnel may be accelerated. In the first example of this aspect of the disclosure, a specialized Information Element (IE) inside the WLAN Beacon may be delivered at a 100 ms periodicity. In this mode, the worst case delay for the receipt of the Paging Message at the remote UE 115 may be the sum of 100 ms, the WAN radio warm-up time, and the channel acquisition time. In another example of this aspect of the disclosure, a specialized vendor proprietary Action Frame with PCF Interface Space (PIFS) channel access may be used for prioritized delivery. If WLAN STA is awake, then it gets the Paging Message immediately over the prioritized medium access. If WLAN STA is in Power Save mode, then the Paging Message may be received at the next beacon with a unicast Traffic Indication Map (TIM) notification. As an Unicast frame, the receipt of the Paging Message may be guaranteed. These periodic information messages delivered by base station or Core Network to all connected UEs. In one example, the proxy UE 115 can deliver the messages via the AP 106 DTIM Broad/Multi-cast messages. In another example, the messages can be delivered to the remote UE 115 as specially marked data frames.

In another example, the functionality of multi-radio gateway 210 may be scaled to devices with smaller form factors, such as smartphones, that have a single multi-radio gateway 210 and cannot virtualize a large number of remote UE contexts. WAN technology supports the concept of “Soft-AP” (S-AP) whereby an AP 106 instance is spawned that is independent of a prevailing STA connection. Once a S-AP is spawned, it creates a WLAN cell and may serve as a Paging Hot-Spot for all the other multi-radio devices in the area by providing them a tunneled WAN link to offload paging. In some examples, ad-hoc paging hot-spots can be created inside a car, in a room, or anywhere there may be a set of trusted multi-radio devices, thereby increasing battery life for all devices that have offloaded paging responsibilities.

In another example, multi-radio gateway 210 can include separate antenna chains for simultaneous transmission and reception over disparate frequency bands, as in Frequency Division Duplex (FDD) LTE. Such a device can allow one proxy UE 115 to be received in download while another proxy UE 115 transmits in the upload. In this mode, the proxy UE 115 can offload connected mode sessions for multiple remote UEs 115. In this connected mode offload, the remote UE 115 maintains only one WLAN link, with the WAN shut off. In one example, the connected mode offload can support a Voice over LTE (VoLTE) or 3G/2G voice call over the tunneled link.

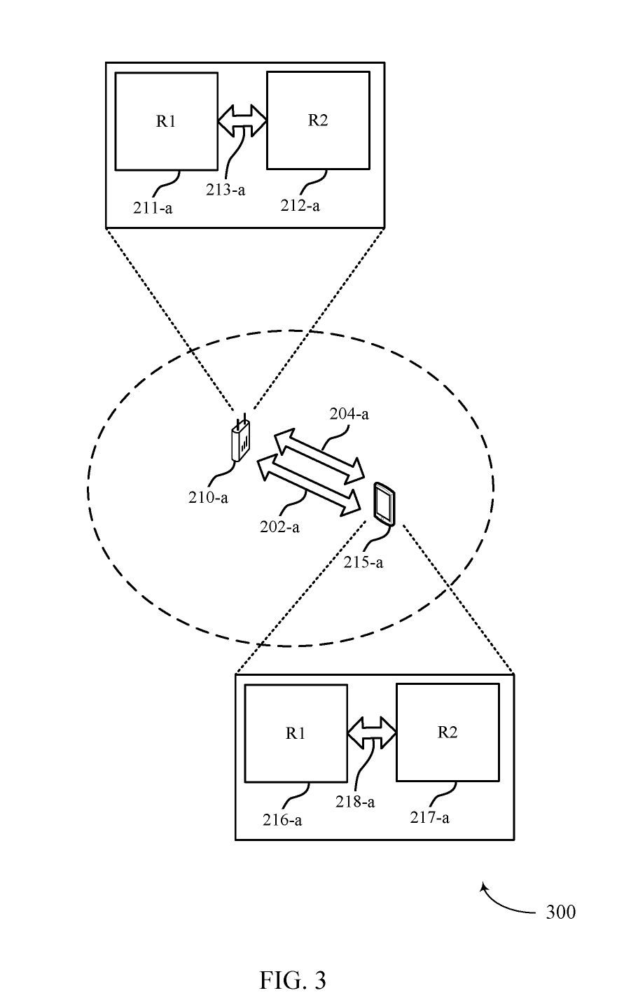

FIG. 3 illustrates an example of small cell multi-radio gateway system 300 with wide area network tunneling in accordance with various aspects of the present disclosure. Small cell multi-radio gateway system 300 may include multi-radio device 215-a and multi-radio gateway 210-a, which may be an example of a small cell base station 105 such as a femtocell.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

Multi-radio device 215-a may include a first radio 216-a and a second radio 217-a connected by a bridge 218-a. Small cell multi-radio gateway system 300 is described using an example of a device with a WAN radio and a WLAN radio, but other combinations are possible for both multi-radio device 215-a and multi-radio gateway 210-a). For example, the first radio may support a WLAN STA whereas the second radio may support a WAN remote UE 115. Multi-radio device 215-a may communicate with base station 105-a via WAN connection 202 and with multi-radio gateway 210-a via WAN connection 202-a and WLAN connection 204-a.

Multi-radio gateway 210-a may include a first radio 211-a and a second radio 212-a connected by bridge 213-a. For example, multi-radio gateway 210-a may house both a WLAN AP 106 and a WAN base station 105. The WLAN Access Point component may include WLAN modem hardware and new WLAN AP software solution. In addition to these two discrete components, multi-radio gateway 210-a also contains a WAN-WLAN bridge 213-a that helps tunnel messages between the two protocols.

That is, a small base station 105 such as a femtocell could be augmented to act as a multi-radio gateway 210-a. In one example, the collocated base station 105 routes all paging indications over tunneled WLAN connections. The remote UE 115 disconnects and shuts down the WAN modem connection with base station 105-a and instead utilizes the WLAN framework for all DL control, broadcast, or multicast transmissions.

Thus, multi-radio device 215-a may establish a first wireless connection with a multi-radio gateway. Multi-radio device 215-a may receive an indication that multi-radio gateway 210-a may be capable of communicating via a second wireless connection, such that the second wireless connection consumes less power than the first wireless connection. Multi-radio device 215-a may establish the second wireless connection with multi-radio gateway based on the indication. Multi-radio device 215-a may close a PHY connection of the first wireless connection based on the second wireless connection. Multi-radio device 215-a may receive a message from multi-radio gateway 210-a via the second wireless connection. Multi-radio device 215-a may enter an idle mode for the first wireless connection, such that establishing the second wireless connection may be based on entering the idle mode. In some examples the message may be a paging message, a control message, a broadcast message, or a multicast message. Multi-radio device 215-a may reopen the PHY connection based on the message. In some examples closing the PHY connection includes powering down at least one component of a radio associated with the first wireless connection.

From the perspective of multi-radio gateway 210-a, the same procedure may include establishing a first wireless connection with a multi-radio device 215-a. Multi-radio gateway 210-a may determine that multi-radio device 215-a may be capable of communicating via a second wireless connection. Multi-radio gateway 210-a may establish a second wireless connection with multi-radio device 215-a based on the determination. Multi-radio gateway 210-a may refrain from sending data over the first wireless connection based on the second wireless connection. Multi-radio gateway 210-a may receive a message for multi-radio device 215-a from a core network entity. Multi-radio gateway 210-a may transmit the message to multi-radio device 215-a via the second wireless connection. Multi-radio gateway 210-a may resume communications over the first wireless component based on the message.

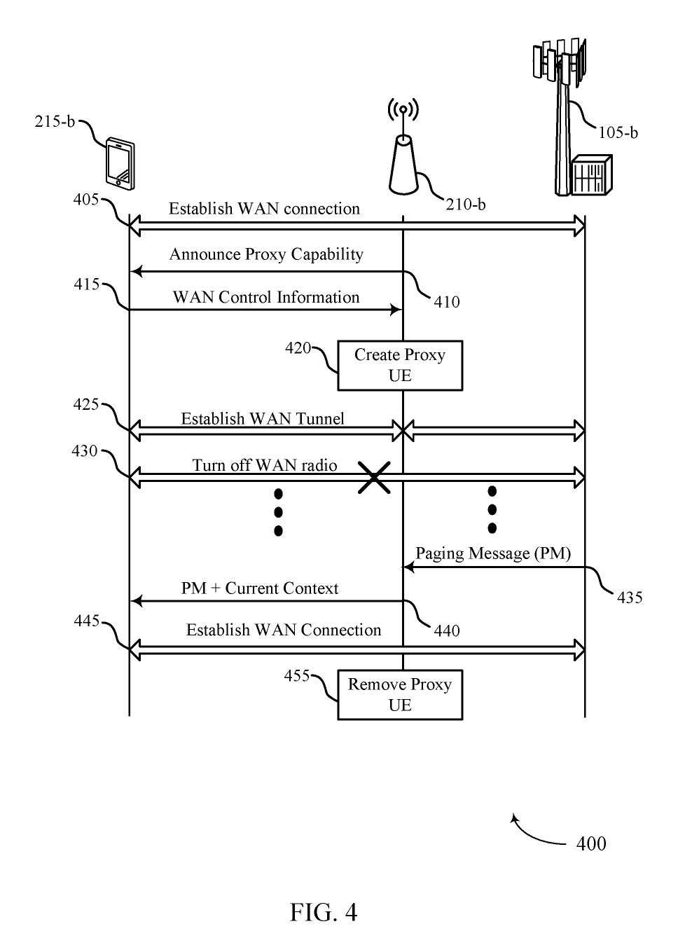

FIG. 4 illustrates an example of a Process flow 400 for a multi-radio gateway with wide area network tunneling in accordance with various aspects of the present disclosure. Process flow 400 may include a multi-radio device 215-b, a multi-radio gateway 210-b, and base station 105-b, which may be examples of a multi-radio device 215, multi-radio gateway 210 and base station 105 described with reference to FIGS. 1-3.

At step 405, multi-radio device 215-b may establish a first wireless connection (e.g., a WAN connection) with multi-radio gateway 210-b and a second wireless connection (e.g., a WAN connection) with base station 105-b. In some cases, multi-radio device 215-b may transmit a proxy request message to multi-radio gateway 210-b. Multi-radio gateway 210-b may receive a proxy request message from multi-radio device 215-b via the first wireless connection. In some examples, multi-radio gateway 210-b may establish an additional local connection with each of one or more additional multi-radio devices 215.

At step 410, multi-radio gateway 210-b may transmit a proxy capability indication to a multi-radio device via a first wireless connection. In some examples, the proxy capability indication may be transmitted in response to the proxy request message. Multi-radio device 215-b may then receive the proxy capability indication from multi-radio gateway 210-b. In some examples the proxy capability indication is transmitted and received in a beacon message via the first wireless connection.

At step 415, multi-radio device 215-b may transmit connection information to multi-radio gateway 210-b based on the proxy capability indication, such that the connection information relates to the second wireless connection. Multi-radio gateway 210-b may then receive connection information from multi-radio device 215-b in response to the proxy capability indication.

At step 420, multi-radio gateway 210-b may establish a proxy entity for a second wireless connection associated with multi-radio device 215-b based on the connection information. In some examples, multi-radio gateway 210-b may establish an additional proxy connection for each of the one or more additional multi-radio devices.

At step 425, multi-radio device 215-b may establish a tunnel to base station 105-b utilizing a proxy entity within multi-radio gateway 210-b, such that the proxy entity may be capable of communicating with base station 105-b based on the connection information.

At step 430, multi-radio device 215-b may close a physical (PHY) connection of the second wireless connection based on the tunnel. In some examples closing the PHY connection includes powering down at least one component of a radio associated with the second wireless connection.

At step 435, multi-radio gateway 210-b may receive a message for multi-radio device 215-b via the second wireless connection. In some examples the message includes a paging message. Multi-radio gateway 210-b may identify a paging group of multi-radio device 215-b, such that the message may be tunneled based on the paging group. In some examples the message is a broadcast or multicast message.

In some examples, multi-radio gateway 210-b may receive UL data from a set of the one or more additional multi-radio devices. Multi-radio gateway 210-b may transmit the UL data to base station 105-b using different frequency resources for each of the set of the one or more additional multi-radio devices.

At step 440, multi-radio gateway 210-b may tunnel the message to multi-radio device 215-b via the first wireless connection. In some examples the message is tunneled using a unicast message of the first wireless connection. Alternatively, the message may be tunneled using a DTIM broadcast or multicast message. Multi-radio device 215-b may receive a message from multi-radio gateway 210-b, such that the message may be a broadcast or multicast message from base station 105-b.

For example, multi-radio device 215-b may receive a paging message from base station 105-b via the tunnel. In some examples the paging message is transmitted via a beacon message. In some examples the paging message is transmitted in a vendor specific action frame with prioritized interframe space (PIFS) access. In some examples, multi-radio device 215-b or multi-radio gateway 210-b may terminate the tunnel based on the paging message.

In some examples, multi-radio device 215-b may receive data related to the second wireless connection via the tunnel after the data may be sent from base station 105-b to the proxy entity of multi-radio gateway 210-b. In some examples, multi-radio gateway 210-b may tunnel data from base station 105-b to the one or more additional multi-radio devices via the additional proxy connections and the additional local connections. Multi-radio device 215-b may receive context information for the second wireless connection from multi-radio gateway 210-b.

In some examples, multi-radio gateway 210-b may identify a tunnel disconnect condition. Multi-radio gateway 210-b may transfer context information for the proxy connection to multi-radio device 215-b based on the tunnel disconnect condition. In some examples, multi-radio device 215-b may transmit a tunnel disconnect message to multi-radio gateway 210-b, such that the context information may be received in response to the tunnel disconnect message. In some examples the context information is received based on a multi-radio gateway initiated disconnect procedure.

In some cases multi-radio device 215-b may determine that the proxy entity is disabled, identify a cell that the proxy entity is camped on, and perform a cell selection procedure for the identified cell based at least in part on the determination that the proxy entity is disabled.

In step 445, multi-radio device 215-b may reestablish the PHY connection based on the paging message. In some examples the paging message is received in a beacon via the first wireless connection. In some examples the paging message is received in an vendor specific action frame with prioritized interframe space (prioritized interframe space (PIFS)) access. Multi-radio device 215-b may resume the PHY connection based on the received context information. Multi-radio device 215-b may reestablish the second wireless connection with a second base station. Multi-radio device 215-b may perform an abbreviated timing alignment procedure based on the context information, such that resuming the PHY connection may be based on the abbreviated timing alignment procedure.

At step 450, multi-radio gateway 210-b may terminate the proxy connection based on the tunnel disconnect condition. In some examples identifying the tunnel disconnect condition includes receiving a tunnel disconnect message from multi-radio device 215-b. In some examples identifying the tunnel disconnect condition includes receiving a paging message for multi-radio device 215-b from base station 105-b. In some examples, multi-radio device 215-b may close the tunnel based on the received context information.

In some cases (not shown), multi-radio device 215-b may move to a location outside a region of base station 105-b. In some examples, multi-radio gateway 210-b may identify an area update trigger condition. In some examples multi-radio gateway 210-b may transmit a reconnection request to multi-radio device 215-b based on the identified area update trigger condition. Alternatively, multi-radio gateway 210-b may perform an area update procedure for the second wireless connection based on the identified area update trigger condition. In some examples the area update trigger condition is related to a tracking area update, a location area update, or a routing area update.

Multi-radio device 215-b may receive one or more connection parameters from multi-radio gateway 210-b based on moving to the location, such that reestablishing the second wireless connection and performing the area update procedure are based on the one or more connection parameters. In some examples the region of base station 105-b includes a tracking area, a location area, or a routing area of base station 105-b. Multi-radio device 215-b may receive a reconnection request for the second wireless connection from multi-radio gateway 210-b, such that reestablishing the second wireless connection and performing the area update procedure are based on the reconnection request. Multi-radio device 215-b may perform an area update procedure based on the reestablished second wireless connection.

In other examples (not shown), multi-radio device 215-b may move to a location outside a basic service set (BSS) associated with an AP multi-radio gateway 210-b. Multi-radio device 215-b may perform a cell acquisition procedure for the second base station based on moving to the location.

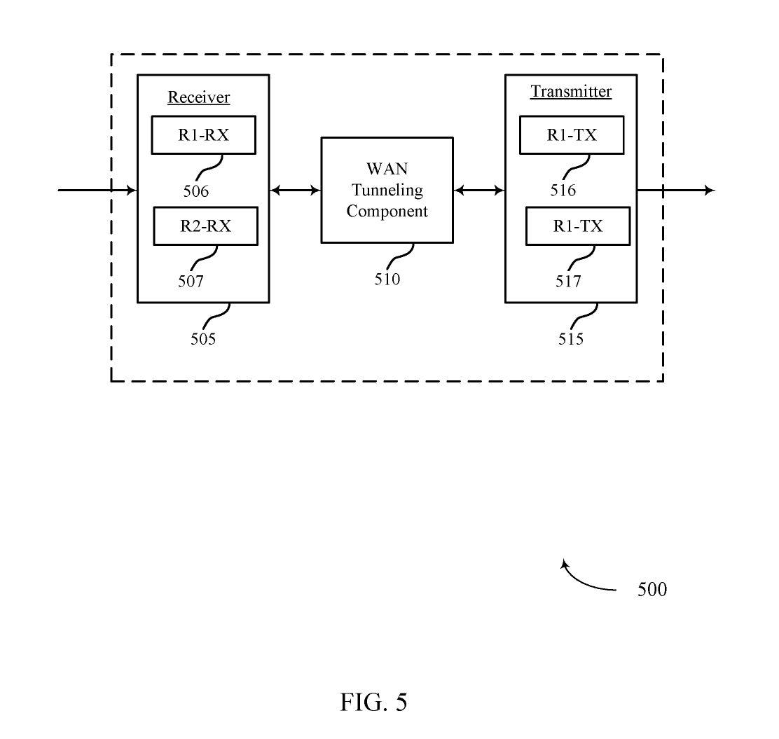

FIG. 5 shows a block diagram of a wireless device 500 configured for a multi-radio gateway with wide area network tunneling in accordance with various aspects of the present disclosure. Wireless device 500 may be an example of aspects of a multi-radio device 215 described with reference to FIGS. 1-4. Wireless device 500 may include a receiver 505, a wide area network (WAN) tunneling component 510, or a transmitter 515. Wireless device 500 may also include a processor. Each of these components may be in communication with each other.

The receiver 505 may include a circuit or circuitry for receiving information such as packets, user data, or control information associated with various information channels (e.g., control channels, data channels, and information related to a multi-radio gateway with wide area network tunneling, etc.). Information may be passed on to the WAN tunneling component 510, and to other components of wireless device 500. Receiver 505 may include a first radio receiver 506 and a second radio receiver 507 associated with two different radio access technologies.

In some examples, the receiver 505 may receive data related to a wireless connection via a tunnel after the data is sent from the base station to the proxy entity of a multi-radio gateway. In some examples, the receiver 505 may receive a message from the multi-radio gateway, where the message is a paging message, a broadcast or a multicast message from the base station. In some examples, the message is received in a DTIM broadcast or multicast message via a first wireless connection. In some examples, the message is received in a unicast packet via the first wireless connection. In some examples, the receiver 505 may receive a reconnection request for the second wireless connection from the multi-radio gateway, such that reestablishing a second wireless connection and performing the area update procedure are based on the reconnection request. In some examples, the receiver 505 may receive a message from the multi-radio gateway via the second wireless connection.

The WAN tunneling component 510 may include a circuit or circuitry to establish a first wireless connection with a multi-radio gateway and a second wireless connection with base station 105-b, receive a proxy capability indication from the multi-radio gateway, transmit connection information to the multi-radio gateway based on the proxy capability indication, such that the connection information relates to the second wireless connection, establish a tunnel to the base station utilizing a proxy entity within the multi-radio gateway, such that the proxy entity is capable of communicating with the base station based on the connection information, and close a PHY connection of the second wireless connection based on the tunnel.

The transmitter 515 may include a circuit or circuitry for transmitting signals received from other components of wireless device 500. In some examples, the transmitter 515 may be collocated with the receiver 505 in a transceiver component. The transmitter 515 may include a single antenna, or it may include a plurality of antennas. The transmitter 515 may include a first radio transmitter 516 and a second radio transmitter 517 associated with two different radio access technologies. In some cases transmitter 515 may be collocated with receiver 505, or the first radio transmitter 516 may be collocated with the first radio receiver 506 and the second radio transmitter 517 may be collocated with the second radio receiver 507. That is, wireless device 500 may include one or more combined transceiver components.

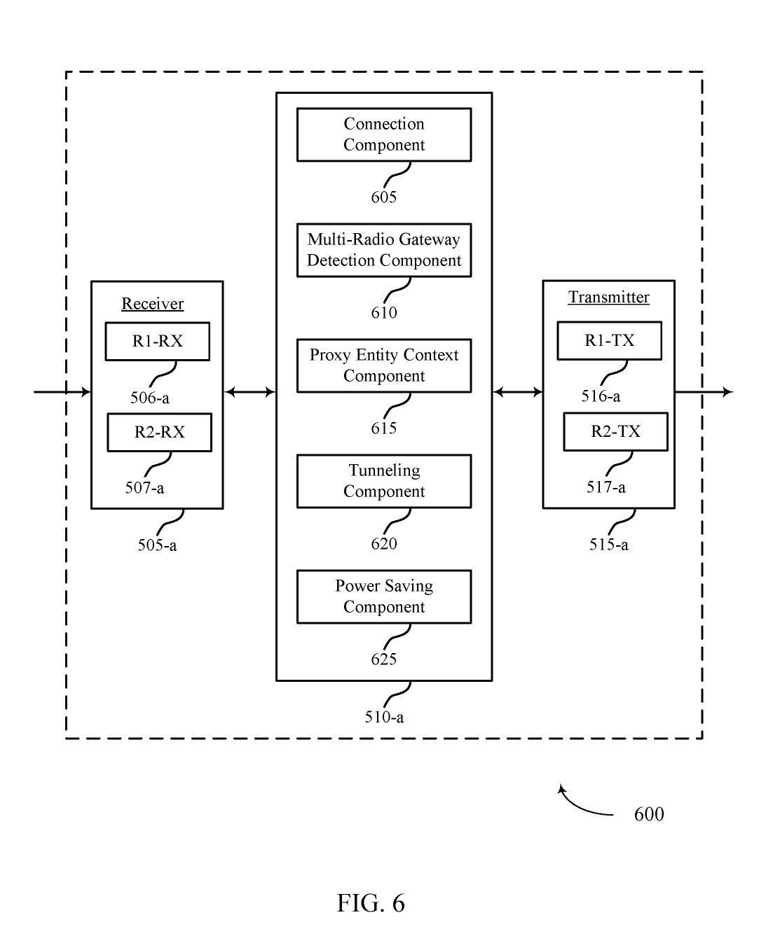

FIG. 6 shows a block diagram of a wireless device 600 for a multi-radio gateway with wide area network tunneling in accordance with various aspects of the present disclosure. Wireless device 600 may be an example of aspects of a wireless device 500 or a multi-radio device 215 described with reference to FIGS. 1-5. Wireless device 600 may include a receiver 505-a, a WAN tunneling component 510-a, or a transmitter 515-a. Wireless device 600 may also include a processor. Each of these components may be in communication with each other. The WAN tunneling component 510-a may also include a connection component 605, a multi-radio gateway detection component 610, a proxy entity context component 615, a tunneling component 620, and a power saving component 625.

The receiver 505-a may receive information which may be passed on to WAN tunneling component 510-a, and to other components of wireless device 600. The WAN tunneling component 510-a may perform the operations described with reference to FIG. 5. The transmitter 515-a may transmit signals received from other components of wireless device 600.

The connection component 605 may include a circuit or circuitry for establishing a first wireless connection with a multi-radio gateway and a second wireless connection with a base station as described with reference to FIGS. 2-4. In some examples, the first wireless connection includes a wireless local area network connection, and the second wireless connection includes a wide area network connection. The connection component 605 may also reestablish the PHY connection based on the paging message. The connection component 605 may also resume the PHY connection based on the received context information. The connection component 605 may also reestablish the second wireless connection with a second base station. The connection component 605 may establish a connection when a multi-radio device 215 moves to a location outside a basic service set (BSS) associated with an AP of the multi-radio gateway. The connection component 605 may also perform a cell acquisition procedure for the second base station based on moving to the location.

The connection component 605 may also establish the first wireless connection with the multi-radio gateway based on the indication. That is, in some examples, the first wireless connection includes a wide area network connection and the second wireless connection includes a local area network connection. The connection component 605 may also reopen a PHY connection based on the message.

The multi-radio gateway detection component 610 may include a circuit or circuitry for receiving a proxy capability indication from the multi-radio gateway as described with reference to FIGS. 2-4. In some examples, the proxy capability indication may be received in a beacon message via the first wireless connection. The multi-radio gateway detection component 610 may also receive an indication that the multi-radio gateway is capable of communicating via a second wireless connection, such that the second wireless connection consumes less power than the first wireless connection.

The proxy entity context component 615 may include a circuit or circuitry for transmitting connection information to the multi-radio gateway based on the proxy capability indication, such that the connection information relates to the second wireless connection as described with reference to FIGS. 2-4.

The tunneling component 620 may include a circuit or circuitry for establishing a tunnel to the base station utilizing a proxy entity within the multi-radio gateway, such that the proxy entity is capable of communicating with the base station based on the connection information as described with reference to FIGS. 2-4. In some examples, the message may be a broadcast or multicast message. In some examples, the message may be tunneled using a DTIM broadcast or multicast message of the first wireless connection. In some examples, the message may be tunneled using a unicast message of the first wireless connection.

The power saving component 625 may include a circuit or circuitry for closing a PHY connection of the second wireless connection based on the tunnel as described with reference to FIGS. 2-4. In some examples, closing the PHY connection includes powering down at least one component of a radio associated with the second wireless connection. The power saving component 625 may also close a PHY connection of the first wireless connection based on the second wireless connection. The power saving component 625 may also enter an idle mode for the first wireless connection, such that establishing the second wireless connection is based on entering the idle mode. In some examples, closing the PHY connection includes powering down at least one component of a radio associated with the first wireless connection.

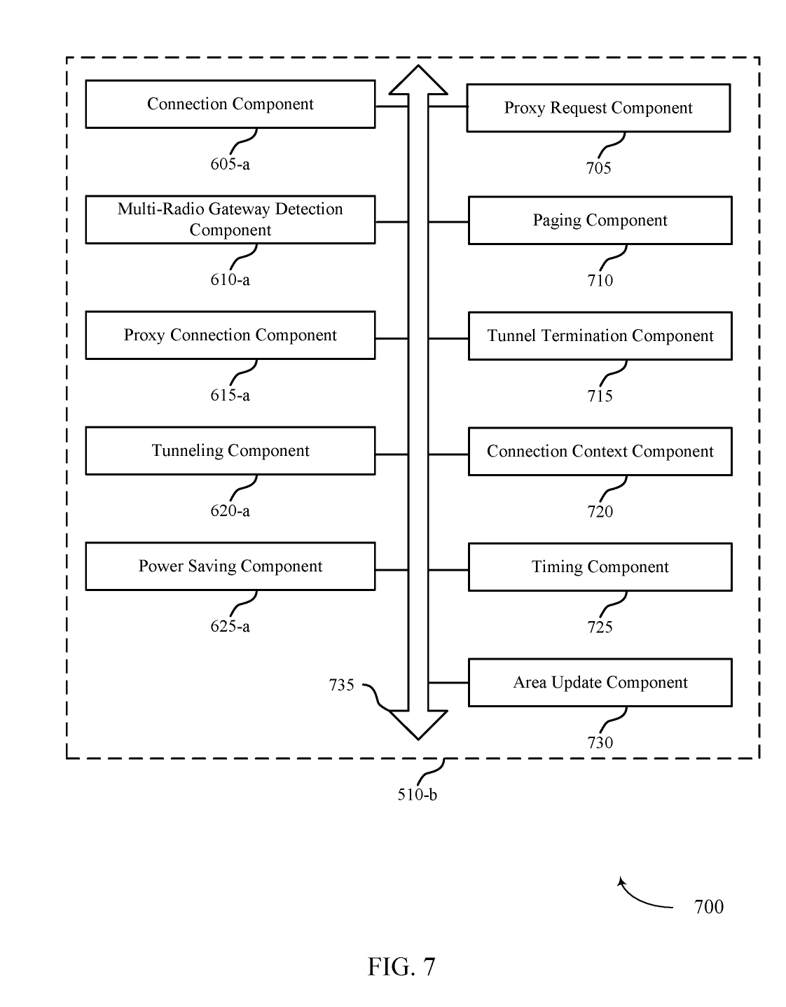

FIG. 7 shows a block diagram 700 of a WAN tunneling component 510-b which may be a component of a wireless device 500 or a wireless device 600 for a multi-radio gateway with wide area network tunneling in accordance with various aspects of the present disclosure. The WAN tunneling component 510-b may be an example of aspects of a WAN tunneling component 510 described with reference to FIGS. 5-6. The WAN tunneling component 510-b may include a connection component 605-a, a multi-radio gateway detection component 610-a, a proxy entity context component 615-a, a tunneling component 620-a, and a power saving component 625-a. Each of these components may perform the functions described with reference to FIG. 6. The WAN tunneling component 510-b may also include a proxy request component 705, a paging component 710, a tunnel termination component 715, a connection context component 720, a timing component 725, and an area update component 730. Each of these components may be in communication, directly or indirectly, with one another (e.g., over bus system 735).

The proxy request component 705 may include a circuit or circuitry for transmitting a proxy request message to the multi-radio gateway, such that the proxy capability indication is received in response to the proxy request message as described with reference to FIGS. 2-4.

The paging component 710 may include a circuit or circuitry for receiving a paging message from the base station via the tunnel as described with reference to FIGS. 2-4. In some examples, the paging message may be received in a beacon via the first wireless connection. In some examples, the paging message may be received in an vendor specific action frame with prioritized interframe space (PIFS) access. In some examples, the paging message may be transmitted via a beacon message.

The tunnel termination component 715 may include a circuit or circuitry for terminating the tunnel based on the paging message as described with reference to FIGS. 2-4. The tunnel termination component 715 may also close the tunnel based on the received context information. The tunnel termination component 715 may also transmit a tunnel disconnect message to the multi-radio gateway, such that the context information is received in response to the tunnel disconnect message. The tunnel termination component 715 may also identify a tunnel disconnect condition. In some examples, identifying the tunnel disconnect condition includes receiving a paging message.

The connection context component 720 may include a circuit or circuitry for receiving context information for the second wireless connection from the multi-radio gateway as described with reference to FIGS. 2-4. In some examples, the context information may be received based on a multi-radio gateway initiated disconnect procedure.

The timing component 725 may include a circuit or circuitry for performing an abbreviated timing alignment procedure based on the context information, such that resuming the PHY connection is based on the abbreviated timing alignment procedure as described with reference to FIGS. 2-4.

The area update component 730 may include a circuit or circuitry for performing an area update procedure based on a second wireless connection as described with reference to FIGS. 2-4. The area update component 730 may also move to a location outside a region of the base station. The area update component 730 may also receive one or more connection parameters from the multi-radio gateway based on moving to the location, such that reestablishing a second wireless connection and performing the area update procedure are based on the one or more connection parameters. In some examples, the region of the base station includes a tracking area, a location area, or a routing area of the base station.

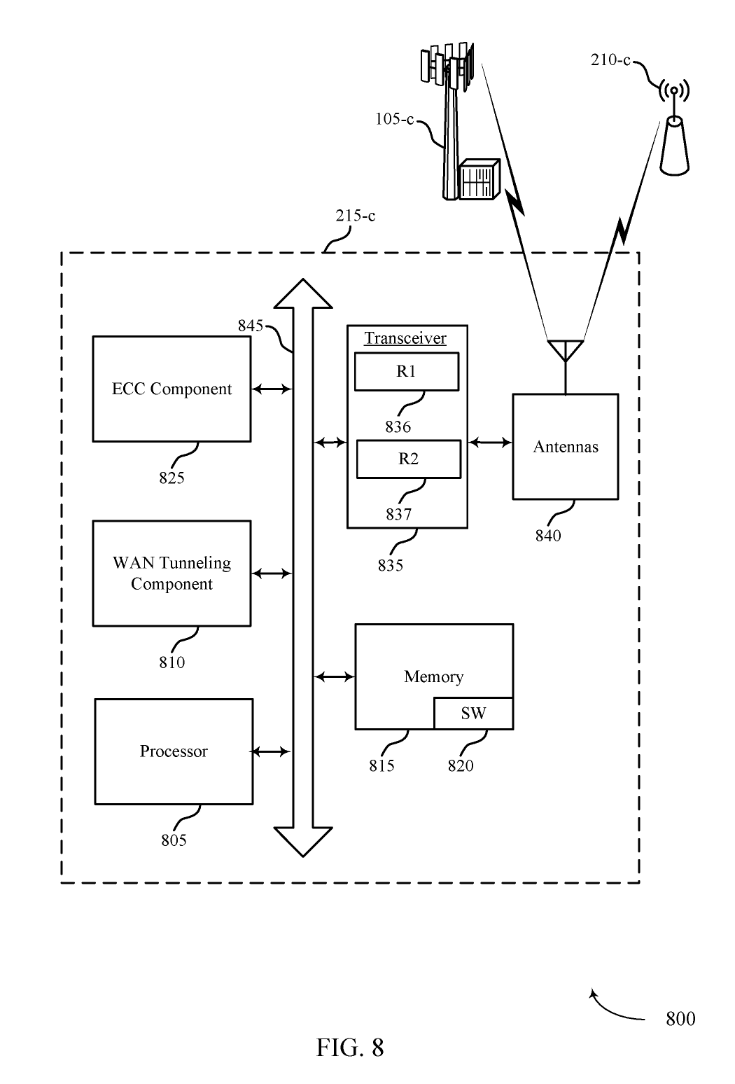

FIG. 8 shows a diagram of a system 800 including a multi-radio device 215 configured for a multi-radio gateway with wide area network tunneling in accordance with various aspects of the present disclosure. System 800 may include multi-radio device 215-c, which may be an example of a wireless device 500, a wireless device 600, or a multi-radio device 215 described with reference to FIGS. 1, 2 and 5-7. Multi-radio device 215-c may include a WAN tunneling component 810, which may be an example of a WAN tunneling component 510 described with reference to FIGS. 5-7. Multi-radio device 215-c may also include a ECC component 825. Multi-radio device 215-c may also include components for bi-directional voice and data communications including components for transmitting communications and components for receiving communications. For example, multi-radio device 215-c may communicate bi-directionally with base station 105-c or multi-radio gateway 210-c.

The ECC component 825 may enable the multi-radio device 215-c to operate using ECCs in an LTE environment as described with reference to FIG. 1.

Multi-radio device 215-c may also include a processor 805, and memory 815 (including software (SW)) 820, a transceiver 835, and one or more antenna(s) 840, each of which may communicate, directly or indirectly, with one another (e.g., via buses 845). The transceiver 835 may communicate bi-directionally, via the antenna(s) 840 or wired or wireless links, with one or more networks, as described above. For example, the transceiver 835 may communicate bi-directionally with a base station 105 or another multi-radio device 215. The transceiver 835 may include a modem to modulate the packets and provide the modulated packets to the antenna(s) 840 for transmission, and to demodulate packets received from the antenna(s) 840. While multi-radio device 215-c may include a single antenna 840, multi-radio device 215-c may also have multiple antennas 840 capable of concurrently transmitting or receiving multiple wireless transmissions.

In some cases, transceiver 835 may include first transceiver components 836 for a first radio and second transceiver components 837 for a second radio.

The memory 815 may include random access memory (RAM) and read only memory (ROM). The memory 815 may store computer-readable, computer-executable software/firmware code 820 including instructions that, when executed, cause the processor 805 to perform various functions described herein (e.g., a multi-radio gateway with wide area network tunneling, etc.). Alternatively, the software/firmware code 820 may not be directly executable by the processor 805 but cause a computer (e.g., when compiled and executed) to perform functions described herein. The processor 805 may include an intelligent hardware device, (e.g., a central processing unit (CPU), a microcontroller, an application specific integrated circuit (ASIC), etc.)

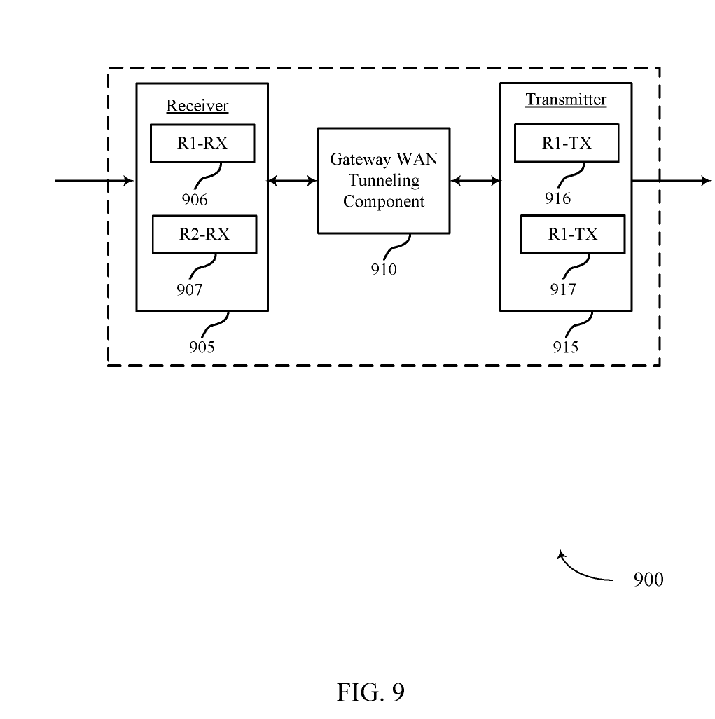

FIG. 9 shows a block diagram of a wireless device 900 configured for a multi-radio gateway with wide area network tunneling in accordance with various aspects of the present disclosure. Wireless device 900 may be an example of aspects of a multi-radio gateway 210 described with reference to FIGS. 1-8. Wireless device 900 may include a receiver 905, a gateway WAN tunneling component 910, or a transmitter 915. Wireless device 900 may also include a processor. Each of these components may be in communication with each other.

The receiver 905 may include a circuit or circuitry for receiving information such as packets, user data, or control information associated with various information channels (e.g., control channels, data channels, and information related to a multi-radio gateway with wide area network tunneling, etc.). Information may be passed on to the gateway WAN tunneling component 910, and to other components of wireless device 900. In some examples, the receiver 905 may receive a message for a multi-radio device via the second of two wireless connections. In some examples, the receiver 905 may receive UL data from a plurality of one or more additional multi-radio devices. In some examples, the receiver 905 may receive a message for the multi-radio device from a core network entity. Receiver 905 may include a first radio receiver 906 and a second radio receiver 907 associated with two different radio access technologies.

The gateway WAN tunneling component 910 may include a circuit or circuitry for transmitting a proxy capability indication to a multi-radio device via a first wireless connection, receive connection information from the multi-radio device in response to the proxy capability indication, establish a proxy entity for a second wireless connection associated with the multi-radio device based on the connection information, receive a message for the multi-radio device via the second wireless connection, and tunnel the message to the multi-radio device via the first wireless connection.

The transmitter 915 may include a circuit or circuitry for transmitting signals received from other components of wireless device 900. In some examples, the transmitter 915 may be collocated with the receiver 905 in a transceiver component. The transmitter 915 may include a single antenna, or it may include a plurality of antennas. In some examples, the transmitter 915 may transmit the UL data to the base station using different frequency resources for each of the plurality of the one or more additional multi-radio devices. In some examples, the transmitter 915 may resume communications over the first wireless connection based on the message. Transmitter 915 may include a first radio transmitter 916 and a second radio transmitter 917 associated with two different radio access technologies.

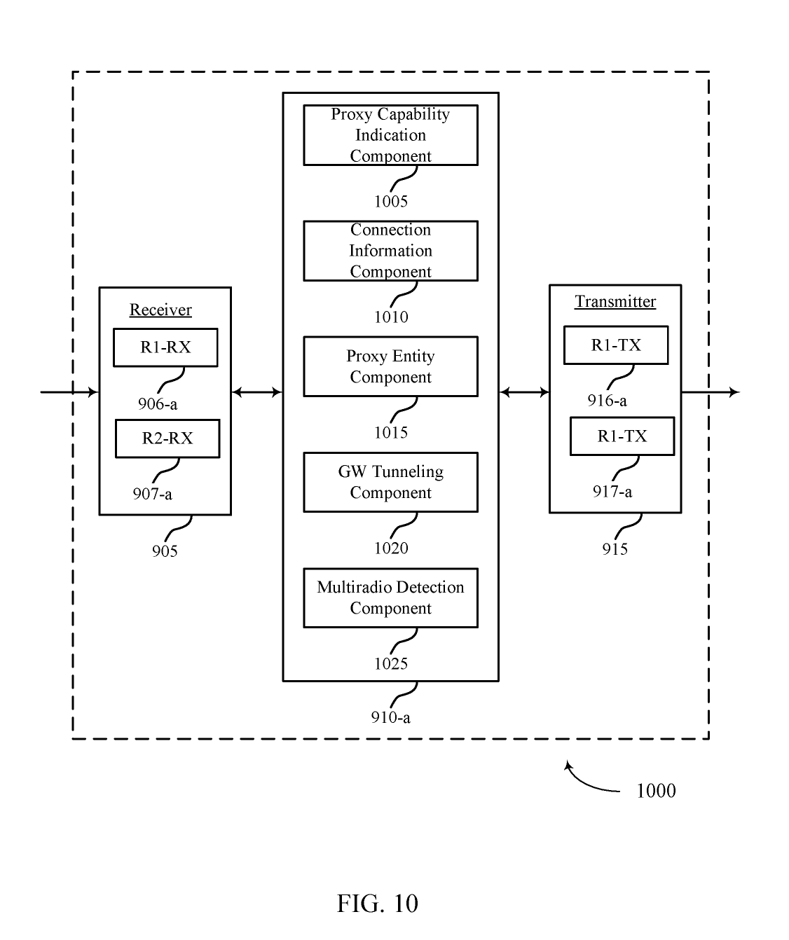

FIG. 10 shows a block diagram of a wireless device 1000 for a multi-radio gateway with wide area network tunneling in accordance with various aspects of the present disclosure. Wireless device 1000 may be an example of aspects of a wireless device 900 or a multi-radio gateway 210 described with reference to FIGS. 1-9. Wireless device 1000 may include a receiver 905-a, a gateway WAN tunneling component 910-a, or a transmitter 915-a. Wireless device 1000 may also include a processor. Each of these components may be in communication with each other. The gateway WAN tunneling component 910-a may also include a proxy capability indication component 1005, a connection information component 1010, a proxy entity component 1015, a gateway (GW) tunneling component 1020, and a multi-radio detection component 1025.

The receiver 905-a may receive information which may be passed on to gateway WAN tunneling component 910-a, and to other components of wireless device 1000. The gateway WAN tunneling component 910-a may perform the operations described with reference to FIG. 9. The transmitter 915-a may transmit signals received from other components of wireless device 1000.

The proxy capability indication component 1005 may include a circuit or circuitry for transmitting a proxy capability indication to a multi-radio device via a first wireless connection as described with reference to FIGS. 2-4. In some examples, the proxy capability indication may be transmitted in a beacon message via the first wireless connection.

The connection information component 1010 may include a circuit or circuitry for receiving connection information from the multi-radio device in response to the proxy capability indication as described with reference to FIGS. 2-4.

The proxy entity component 1015 may include a circuit or circuitry for establishing a proxy entity for a second wireless connection associated with the multi-radio device based on the connection information as described with reference to FIGS. 2-4. The proxy entity component 1015 may also establish an additional proxy entity for each of the one or more additional multi-radio devices.

The GW tunneling component 1020 may include a circuit or circuitry for tunneling the message to the multi-radio device via the first wireless connection as described with reference to FIGS. 2-4.

The multi-radio detection component 1025 may include a circuit or circuitry for determining that the multi-radio device is capable of communicating via a second wireless connection as described with reference to FIGS. 2-4.

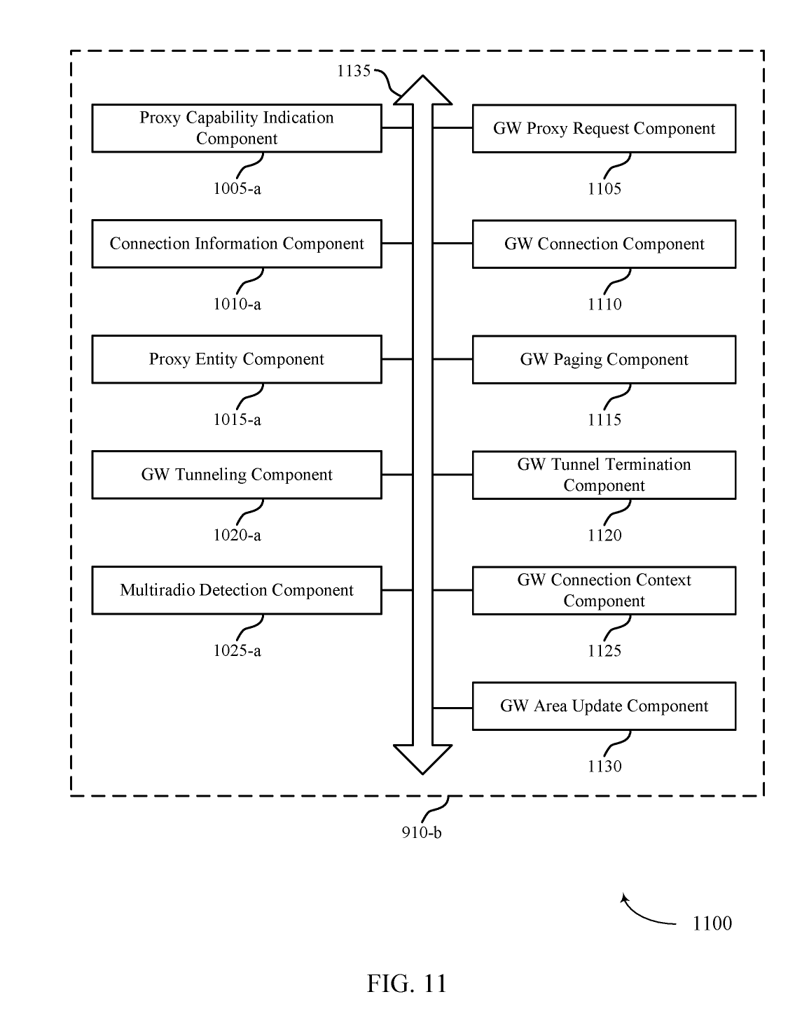

FIG. 11 shows a block diagram 1100 of a gateway WAN tunneling component 910-b which may be a component of a wireless device 900 or a wireless device 1000 for a multi-radio gateway with wide area network tunneling in accordance with various aspects of the present disclosure. The gateway WAN tunneling component 910-b may be an example of aspects of a gateway WAN tunneling component 910 described with reference to FIGS. 9-10. The gateway WAN tunneling component 910-b may include a proxy capability indication component 1005-a, a connection information component 1010-a, a proxy entity component 1015-a, a GW tunneling component 1020-a, and a multi-radio detection component 1025-a. Each of these components may perform the functions described with reference to FIG. 10.

The gateway WAN tunneling component 910-b may also include a GW proxy request component 1105, a GW connection component 1110, a GW paging component 1115, a GW tunnel termination component 1120, a GW connection context component 1125, and a GW area update component 1130. These various components of gateway WAN tunneling component 910-b may be in communication, directly or indirectly, with one another (e.g., over bus system 1135).

The GW proxy request component 1105 may include a circuit or circuitry for receiving a proxy request message from the multi-radio device via a first wireless connection, such that the proxy capability indication is transmitted in response to the proxy request message as described with reference to FIGS. 2-4.

The GW connection component 1110 may establish a first connection with a multi-radio device 215 and a second connection with a base station 105. In some cases the first wireless connection may include a wireless local area network connection, and the second wireless connection may include a wide area network connection as described with reference to FIGS. 2-4.

The GW paging component 1115 may include a circuit or circuitry for such that the message may include a paging message as described with reference to FIGS. 2-4. The GW tunnel termination component 1120 may include a circuit or circuitry for terminating the tunnel, for example, based on the paging message, as described with reference to FIGS. 2-4.

The GW connection context component 1125 may transfer context information for the proxy entity to the multi-radio device based on the tunnel disconnect condition as described with reference to FIGS. 2-4. The GW area update component 1130 may include a circuit or circuitry for identifying an area update trigger condition and performing area update procedures as described with reference to FIGS. 2-4.

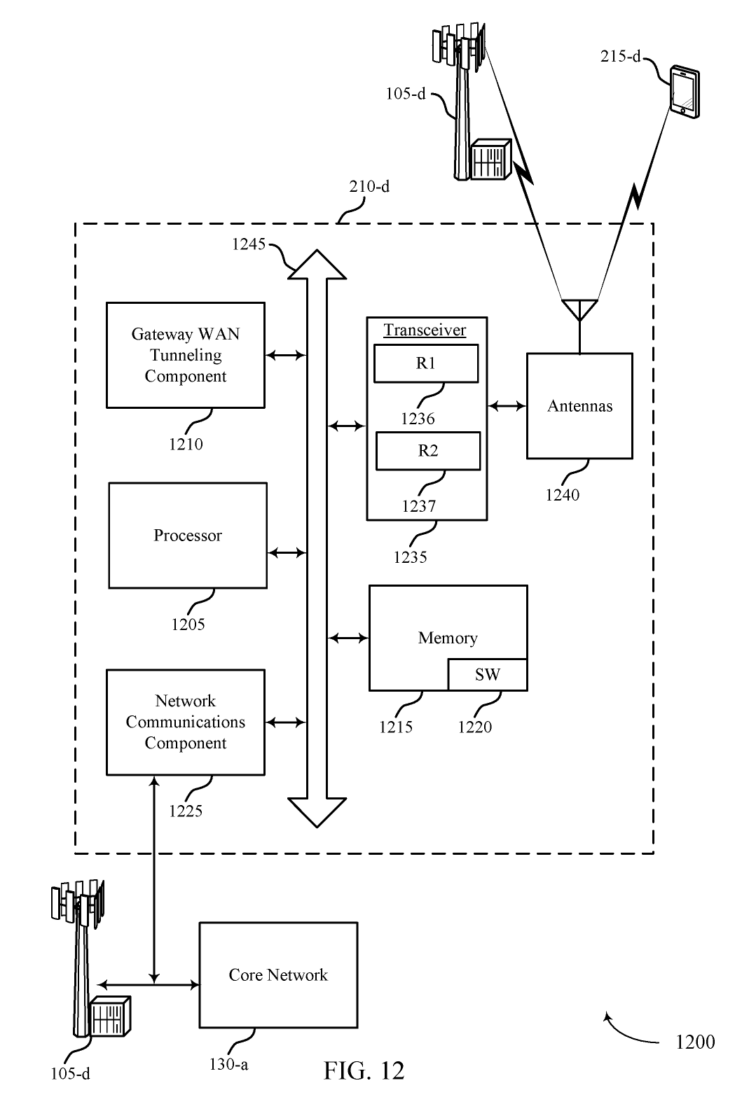

FIG. 12 shows a diagram of a system 1200 including a base station 105 configured for a multi-radio gateway with wide area network tunneling in accordance with various aspects of the present disclosure. System 1200 may include multi-radio gateway 210-d, which may be an example of a wireless device 900, a wireless device 1000, or a base station 105 described with reference to FIGS. 1, 2 and 9-11. Multi-radio gateway 210-d may include a gateway WAN tunneling component 1210, which may be an example of a gateway WAN tunneling component 910 described with reference to FIGS. 9-11. Multi-radio gateway 210-d may also include components for bi-directional voice and data communications including components for transmitting communications and components for receiving communications. For example, multi-radio gateway 210-d may communicate bi-directionally with multi-radio device 215-d or base station 105-d.

In some cases, multi-radio gateway 210-d may have one or more wired backhaul links. For example multi-radio gateway 210-d may have a wired backhaul link (e.g., S1 interface, etc.) to a core network 130-a. Multi-radio gateway 210-d may also communicate with other base stations 105, such as base station 105-d via inter-base station backhaul links (e.g., an X2 interface). Multi-radio gateway 210-d may communicate with multi-radio devices 215 using one or more different wireless communications technologies. In some examples, multi-radio gateway 210-d may communicate with other base stations through core network 130-a. In some cases, multi-radio gateway 210-d may communicate with base station 105-d or core network 130-a through network communications component 1225.

Multi-radio gateway 210-d may include a processor 1205, memory 1215 (including software (SW)1220), transceiver 1235, and antenna(s) 1240, which each may be in communication, directly or indirectly, with one another (e.g., over bus system 1245). The transceivers 1235 may be configured to communicate bi-directionally, via the antenna(s) 1240, with the UEs 115, which may be multi-mode devices. The transceiver 1235 (or other components of multi-radio gateway 210-d) may also be configured to communicate bi-directionally, via the antennas 1240, with one or more other base stations (not shown). The transceiver 1235 may include a modem configured to modulate the packets and provide the modulated packets to the antennas 1240 for transmission, and to demodulate packets received from the antennas 1240. The multi-radio gateway 210-d may include multiple transceivers 1235, each with one or more associated antennas 1240. The transceiver may be an example of a combined receiver 905 and transmitter 915 of FIG. 9. For example, transceiver 1235 may include first radio transceiver 1236 and second radio transceiver 1237 associated with different radio access technologies such as a WLAN and WAN technologies.

The memory 1215 may include RAM and ROM. The memory 1215 may also store computer-readable, computer-executable software code 1220 containing instructions that are configured to, when executed, cause the processor 1205 to perform various functions described herein (e.g., a multi-radio gateway with wide area network tunneling, selecting coverage enhancement techniques, call processing, database management, message routing, etc.). Alternatively, the software 1220 may not be directly executable by the processor 1205 but be configured to cause the computer, e.g., when compiled and executed, to perform functions described herein. The processor 1205 may include an intelligent hardware device, e.g., a CPU, a microcontroller, an ASIC, etc. The processor 1205 may include various special purpose processors such as encoders, queue processing components, base band processors, radio head controllers, digital signal processor (DSPs), and the like.

The network communications component 1225 may manage communications with other base stations 105. In some cases, a communications management component may include a controller or scheduler for controlling communications with UEs 115 in cooperation with other base stations 105. For example, the network communications component 1225 may coordinate scheduling for transmissions to UEs 115 for various interference mitigation techniques such as beamforming or joint transmission.

The components of wireless device 500, wireless device 600, WAN tunneling component 510, system 800, wireless device 900, wireless device 1000, GW WAN tunneling component 910, or system 1200 may, individually or collectively, be implemented with at least one circuit (such as an ASIC) adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

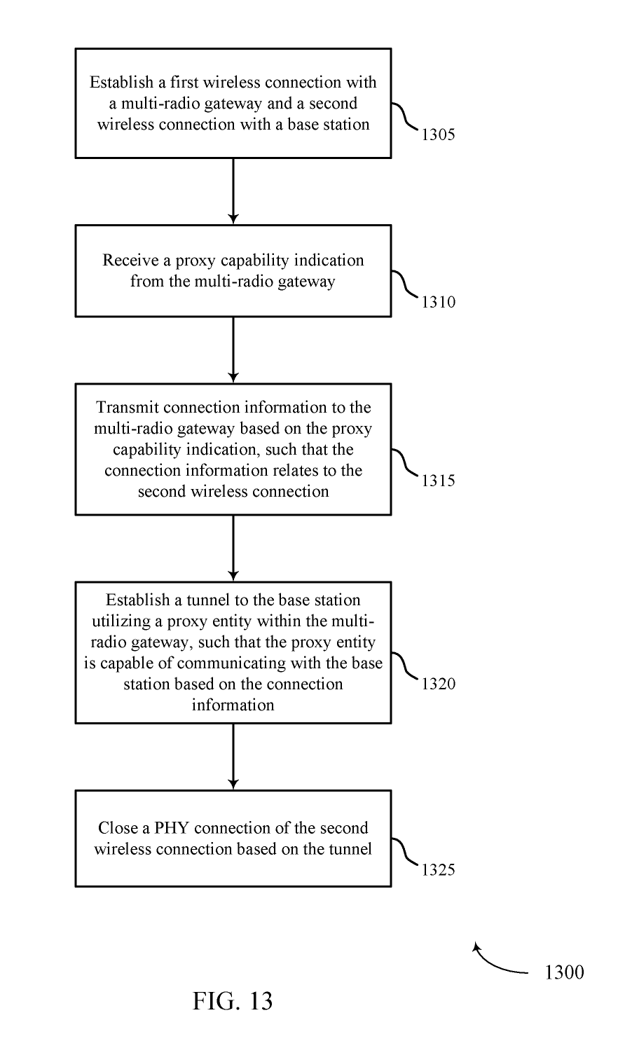

FIG. 13 shows a flowchart illustrating a method 1300 for a multi-radio gateway with wide area network tunneling in accordance with various aspects of the present disclosure. The operations of method 1300 may be implemented by a multi-radio device 215 or its components as described with reference to FIGS. 1-12. For example, the operations of method 1300 may be performed by the WAN tunneling component 510 as described with reference to FIGS. 5-8. In some examples, a multi-radio device 215 may execute a set of codes to control the functional elements of the multi-radio device 215 to perform the functions described below. Additionally or alternatively, the multi-radio device 215 may perform aspects of the functions described below using special-purpose hardware.

At block 1305, the multi-radio device 215 may establish a first wireless connection with a multi-radio gateway and a second wireless connection with a base station as described with reference to FIGS. 2-4. In certain examples, the operations of block 1305 may be performed by the connection component 605 as described with reference to FIG. 6.

At block 1310, the multi-radio device 215 may receive a proxy capability indication from the multi-radio gateway as described with reference to FIGS. 2-4. In certain examples, the operations of block 1310 may be performed by the multi-radio gateway detection component 610 as described with reference to FIG. 6.

At block 1315, the multi-radio device 215 may transmit connection information to the multi-radio gateway based on the proxy capability indication, such that the connection information relates to the second wireless connection as described with reference to FIGS. 2-4. In certain examples, the operations of block 1315 may be performed by the proxy entity context component 615 as described with reference to FIG. 6.

At block 1320, the multi-radio device 215 may establish a tunnel to the base station utilizing a proxy entity within the multi-radio gateway, such that the proxy entity is capable of communicating with the base station based on the connection information as described with reference to FIGS. 2-4. In certain examples, the operations of block 1320 may be performed by the tunneling component 620 as described with reference to FIG. 6.

At block 1325, the multi-radio device 215 may close a PHY connection of the second wireless connection based on the tunnel as described with reference to FIGS. 2-4. In certain examples, the operations of block 1325 may be performed by the power saving component 625 as described with reference to FIG. 6.

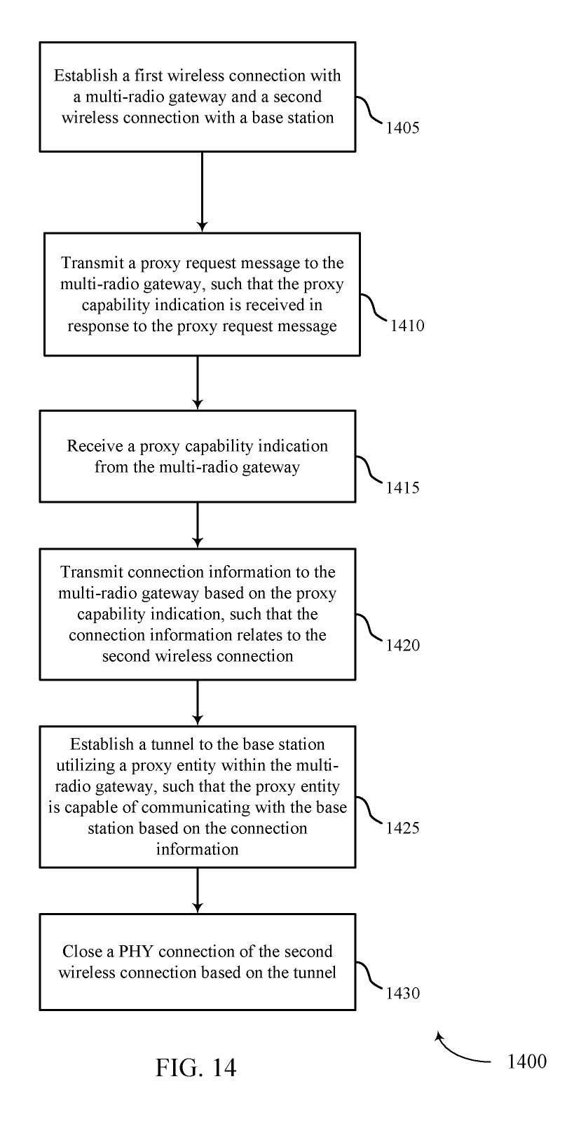

FIG. 14 shows a flowchart illustrating a method 1400 for a multi-radio gateway with wide area network tunneling in accordance with various aspects of the present disclosure. The operations of method 1400 may be implemented by a multi-radio device 215 or its components as described with reference to FIGS. 1-12. For example, the operations of method 1400 may be performed by the WAN tunneling component 510 as described with reference to FIGS. 5-8. In some examples, a multi-radio device 215 may execute a set of codes to control the functional elements of the multi-radio device 215 to perform the functions described below. Additionally or alternatively, the multi-radio device 215 may perform aspects of the functions described below using special-purpose hardware. The method 1400 may also incorporate aspects of method 1300 of FIG. 13.

At block 1405, the multi-radio device 215 may establish a first wireless connection with a multi-radio gateway and a second wireless connection with a base station as described with reference to FIGS. 2-4. In certain examples, the operations of block 1405 may be performed by the connection component 605 as described with reference to FIG. 6.

At block 1410, the multi-radio device 215 may transmit a proxy request message to the multi-radio gateway, such that the proxy capability indication is received in response to the proxy request message as described with reference to FIGS. 2-4. In certain examples, the operations of block 1410 may be performed by the proxy request component 705 as described with reference to FIG. 7.

At block 1415, the multi-radio device 215 may receive a proxy capability indication from the multi-radio gateway as described with reference to FIGS. 2-4. In certain examples, the operations of block 1415 may be performed by the multi-radio gateway detection component 610 as described with reference to FIG. 6.

At block 1420, the multi-radio device 215 may transmit connection information to the multi-radio gateway based on the proxy capability indication, such that the connection information relates to the second wireless connection as described with reference to FIGS. 2-4. In certain examples, the operations of block 1420 may be performed by the proxy entity context component 615 as described with reference to FIG. 6.

At block 1425, the multi-radio device 215 may establish a tunnel to the base station utilizing a proxy entity within the multi-radio gateway, such that the proxy entity is capable of communicating with the base station based on the connection information as described with reference to FIGS. 2-4. In certain examples, the operations of block 1425 may be performed by the tunneling component 620 as described with reference to FIG. 6.

At block 1430, the multi-radio device 215 may close a PHY connection of the second wireless connection based on the tunnel as described with reference to FIGS. 2-4. In certain examples, the operations of block 1430 may be performed by the power saving component 625 as described with reference to FIG. 6.

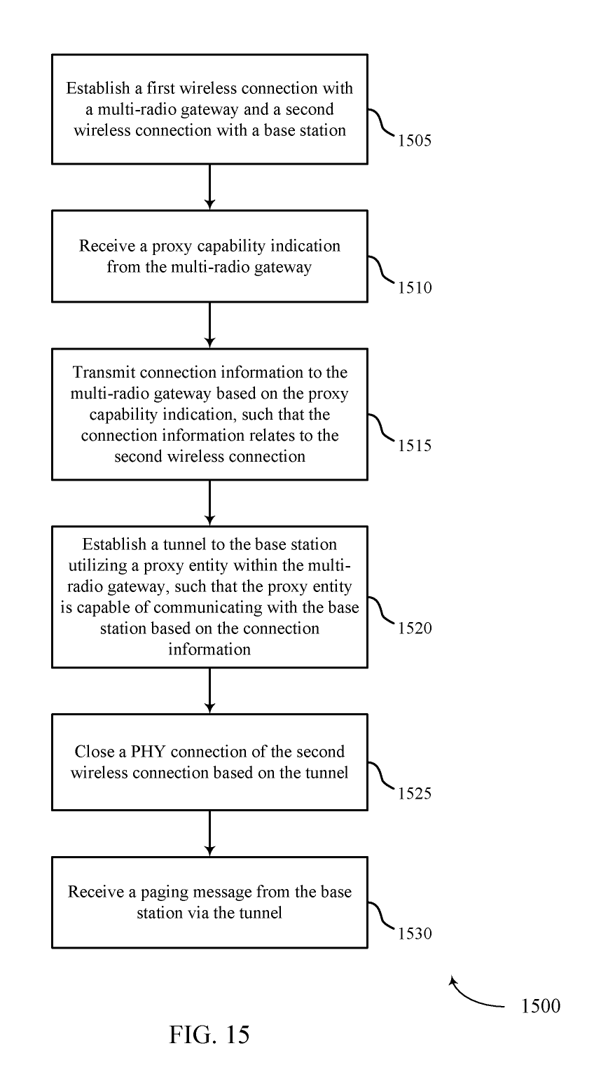

FIG. 15 shows a flowchart illustrating a method 1500 for a multi-radio gateway with wide area network tunneling in accordance with various aspects of the present disclosure. The operations of method 1500 may be implemented by a multi-radio device 215 or its components as described with reference to FIGS. 1-12. For example, the operations of method 1500 may be performed by the WAN tunneling component 510 as described with reference to FIGS. 5-8. In some examples, a multi-radio device 215 may execute a set of codes to control the functional elements of the multi-radio device 215 to perform the functions described below. Additionally or alternatively, the multi-radio device 215 may perform aspects of the functions described below using special-purpose hardware. The method 1500 may also incorporate aspects of methods 1300, and 1400 of FIGS. 13-14.

At block 1505, the multi-radio device 215 may establish a first wireless connection with a multi-radio gateway and a second wireless connection with a base station as described with reference to FIGS. 2-4. In certain examples, the operations of block 1505 may be performed by the connection component 605 as described with reference to FIG. 6.

At block 1510, the multi-radio device 215 may receive a proxy capability indication from the multi-radio gateway as described with reference to FIGS. 2-4. In certain examples, the operations of block 1510 may be performed by the multi-radio gateway detection component 610 as described with reference to FIG. 6.

At block 1515, the multi-radio device 215 may transmit connection information to the multi-radio gateway based on the proxy capability indication, such that the connection information relates to the second wireless connection as described with reference to FIGS. 2-4. In certain examples, the operations of block 1515 may be performed by the proxy entity context component 615 as described with reference to FIG. 6.

At block 1520, the multi-radio device 215 may establish a tunnel to the base station utilizing a proxy entity within the multi-radio gateway, such that the proxy entity is capable of communicating with the base station based on the connection information as described with reference to FIGS. 2-4. In certain examples, the operations of block 1520 may be performed by the tunneling component 620 as described with reference to FIG. 6.

At block 1525, the multi-radio device 215 may close a PHY connection of the second wireless connection based on the tunnel as described with reference to FIGS. 2-4. In certain examples, the operations of block 1525 may be performed by the power saving component 625 as described with reference to FIG. 6.

At block 1530, the multi-radio device 215 may receive a paging message from the base station via the tunnel as described with reference to FIGS. 2-4. In certain examples, the operations of block 1530 may be performed by the paging component 710 as described with reference to FIG. 7.

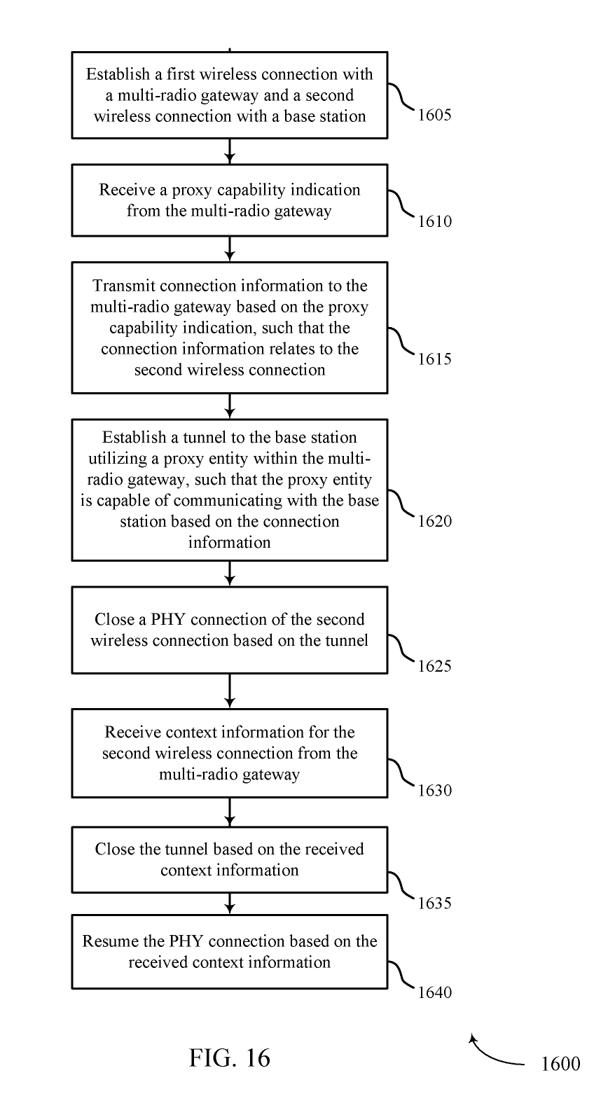

FIG. 16 shows a flowchart illustrating a method 1600 for a multi-radio gateway with wide area network tunneling in accordance with various aspects of the present disclosure. The operations of method 1600 may be implemented by a multi-radio device 215 or its components as described with reference to FIGS. 1-12. For example, the operations of method 1600 may be performed by the WAN tunneling component 510 as described with reference to FIGS. 5-8. In some examples, a multi-radio device 215 may execute a set of codes to control the functional elements of the multi-radio device 215 to perform the functions described below. Additionally or alternatively, the multi-radio device 215 may perform aspects of the functions described below using special-purpose hardware. The method 1600 may also incorporate aspects of methods 1300, 1400, and 1500 of FIGS. 13-15.

At block 1605, the multi-radio device 215 may establish a first wireless connection with a multi-radio gateway and a second wireless connection with a base station as described with reference to FIGS. 2-4. In certain examples, the operations of block 1605 may be performed by the connection component 605 as described with reference to FIG. 6.

At block 1610, the multi-radio device 215 may receive a proxy capability indication from the multi-radio gateway as described with reference to FIGS. 2-4. In certain examples, the operations of block 1610 may be performed by the multi-radio gateway detection component 610 as described with reference to FIG. 6.

At block 1615, the multi-radio device 215 may transmit connection information to the multi-radio gateway based on the proxy capability indication, such that the connection information relates to the second wireless connection as described with reference to FIGS. 2-4. In certain examples, the operations of block 1615 may be performed by the proxy entity context component 615 as described with reference to FIG. 6.

At block 1620, the multi-radio device 215 may establish a tunnel to the base station utilizing a proxy entity within the multi-radio gateway, such that the proxy entity is capable of communicating with the base station based on the connection information as described with reference to FIGS. 2-4. In certain examples, the operations of block 1620 may be performed by the tunneling component 620 as described with reference to FIG. 6.

At block 1625, the multi-radio device 215 may close a PHY connection of the second wireless connection based on the tunnel as described with reference to FIGS. 2-4. In certain examples, the operations of block 1625 may be performed by the power saving component 625 as described with reference to FIG. 6.

At block 1630, the multi-radio device 215 may receive context information for the second wireless connection from the multi-radio gateway as described with reference to FIGS. 2-4. In certain examples, the operations of block 1630 may be performed by the connection context component 720 as described with reference to FIG. 7.

At block 1635, the multi-radio device 215 may close the tunnel based on the received context information as described with reference to FIGS. 2-4. In certain examples, the operations of block 1635 may be performed by the tunnel termination component 715 as described with reference to FIG. 7.

At block 1640, the multi-radio device 215 may resume the PHY connection based on the received context information as described with reference to FIGS. 2-4. In certain examples, the operations of block 1640 may be performed by the connection component 605 as described with reference to FIG. 6.

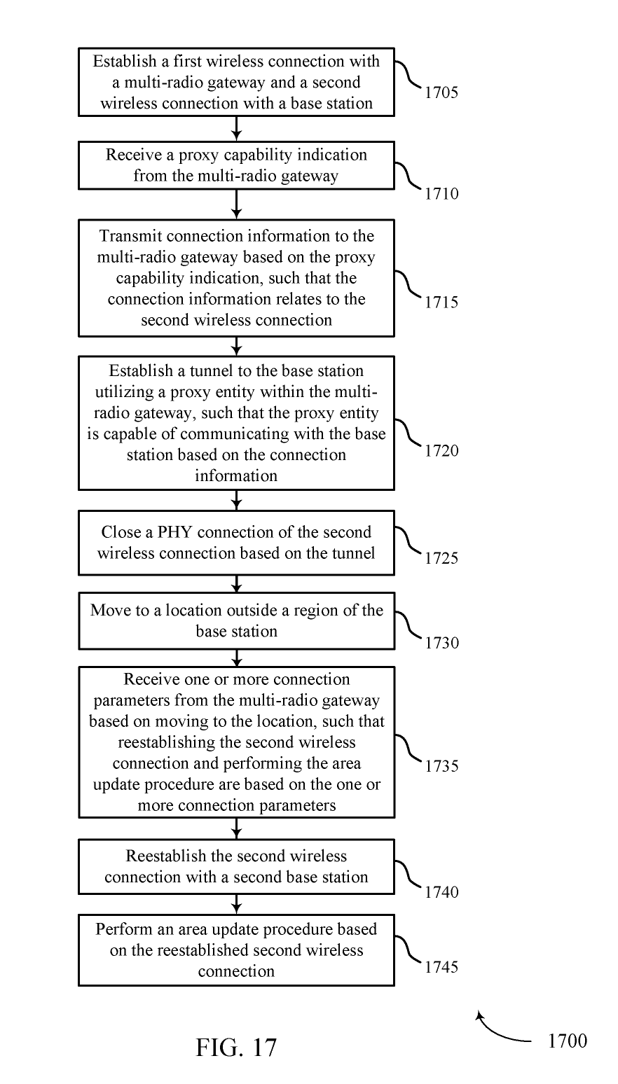

FIG. 17 shows a flowchart illustrating a method 1700 for a multi-radio gateway with wide area network tunneling in accordance with various aspects of the present disclosure. The operations of method 1700 may be implemented by a multi-radio device 215 or its components as described with reference to FIGS. 1-12. For example, the operations of method 1700 may be performed by the WAN tunneling component 510 as described with reference to FIGS. 5-8. In some examples, a multi-radio device 215 may execute a set of codes to control the functional elements of the multi-radio device 215 to perform the functions described below. Additionally or alternatively, the multi-radio device 215 may perform aspects of the functions described below using special-purpose hardware. The method 1700 may also incorporate aspects of methods 1300, 1400, 1500, and 1600 of FIGS. 13-16.

At block 1705, the multi-radio device 215 may establish a first wireless connection with a multi-radio gateway and a second wireless connection with a base station as described with reference to FIGS. 2-4. In certain examples, the operations of block 1705 may be performed by the connection component 605 as described with reference to FIG. 6.

At block 1710, the multi-radio device 215 may receive a proxy capability indication from the multi-radio gateway as described with reference to FIGS. 2-4. In certain examples, the operations of block 1710 may be performed by the multi-radio gateway detection component 610 as described with reference to FIG. 6.

At block 1715, the multi-radio device 215 may transmit connection information to the multi-radio gateway based on the proxy capability indication, such that the connection information relates to the second wireless connection as described with reference to FIGS. 2-4. In certain examples, the operations of block 1715 may be performed by the proxy entity context component 615 as described with reference to FIG. 6.

At block 1720, the multi-radio device 215 may establish a tunnel to the base station utilizing a proxy entity within the multi-radio gateway, such that the proxy entity is capable of communicating with the base station based on the connection information as described with reference to FIGS. 2-4. In certain examples, the operations of block 1720 may be performed by the tunneling component 620 as described with reference to FIG. 6.

At block 1725, the multi-radio device 215 may close a PHY connection of the second wireless connection based on the tunnel as described with reference to FIGS. 2-4. In certain examples, the operations of block 1725 may be performed by the power saving component 625 as described with reference to FIG. 6.

At block 1730, the multi-radio device 215 may move to a location outside a region of the base station as described with reference to FIGS. 2-4. At block 1735, the multi-radio device 215 may reestablish the second wireless connection with a second base station as described with reference to FIGS. 2-4. In certain examples, the operations of block 1735 may be performed by the connection component 605 as described with reference to FIG. 6.

At block 1740, the multi-radio device 215 may perform an area update procedure based on the reestablished second wireless connection as described with reference to FIGS. 2-4. In certain examples, the operations of block 1740 may be performed by the area update component 730 as described with reference to FIG. 7.

At block 1745, the multi-radio device 215 may receive one or more connection parameters from the multi-radio gateway based on moving to the location, such that reestablishing the second wireless connection and performing the area update procedure are based on the one or more connection parameters as described with reference to FIGS. 2-4. In certain examples, the operations of block 1745 may be performed by the area update component 730 as described with reference to FIG. 7.

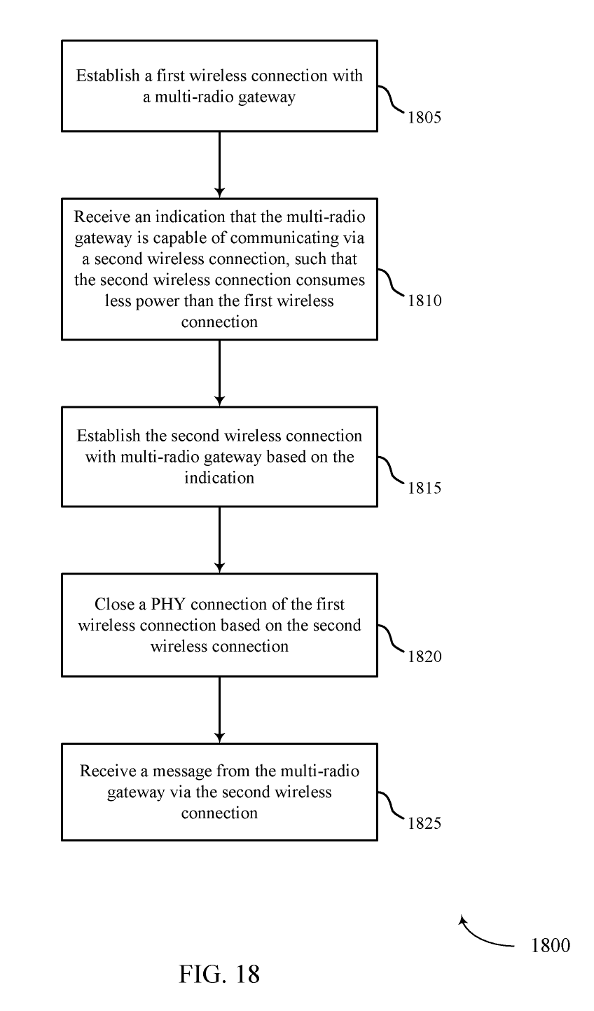

FIG. 18 shows a flowchart illustrating a method 1800 for a multi-radio gateway with wide area network tunneling in accordance with various aspects of the present disclosure. The operations of method 1800 may be implemented by a multi-radio device 215 or its components as described with reference to FIGS. 1-12. For example, the operations of method 1800 may be performed by the WAN tunneling component 510 as described with reference to FIGS. 5-8. In some examples, a multi-radio device 215 may execute a set of codes to control the functional elements of the multi-radio device 215 to perform the functions described below. Additionally or alternatively, the multi-radio device 215 may perform aspects of the functions described below using special-purpose hardware. The method 1800 may also incorporate aspects of methods 1300, 1400, 1500, 1600, and 1700 of FIGS. 13-17.

At block 1805, the multi-radio device 215 may establish a first wireless connection with a multi-radio gateway as described with reference to FIGS. 2-4. In certain examples, the operations of block 1805 may be performed by the connection component 605 as described with reference to FIG. 6.

At block 1810, the multi-radio device 215 may receive an indication that the multi-radio gateway is capable of communicating via a second wireless connection, such that the second wireless connection consumes less power than the first wireless connection as described with reference to FIGS. 2-4. In certain examples, the operations of block 1810 may be performed by the multi-radio gateway detection component 610 as described with reference to FIG. 6.

At block 1815, the multi-radio device 215 may establish the second wireless connection with the multi-radio gateway based on the indication as described with reference to FIGS. 2-4. In certain examples, the operations of block 1815 may be performed by the connection component 605 as described with reference to FIG. 6.

At block 1820, the multi-radio device 215 may close a PHY connection of the first wireless connection based on the second wireless connection as described with reference to FIGS. 2-4. In certain examples, the operations of block 1820 may be performed by the power saving component 625 as described with reference to FIG. 6.

At block 1825, the multi-radio device 215 may receive a message from the multi-radio gateway via the second wireless connection as described with reference to FIGS. 2-4. In certain examples, the operations of block 1825 may be performed by the receiver 505 as described with reference to FIG. 5.

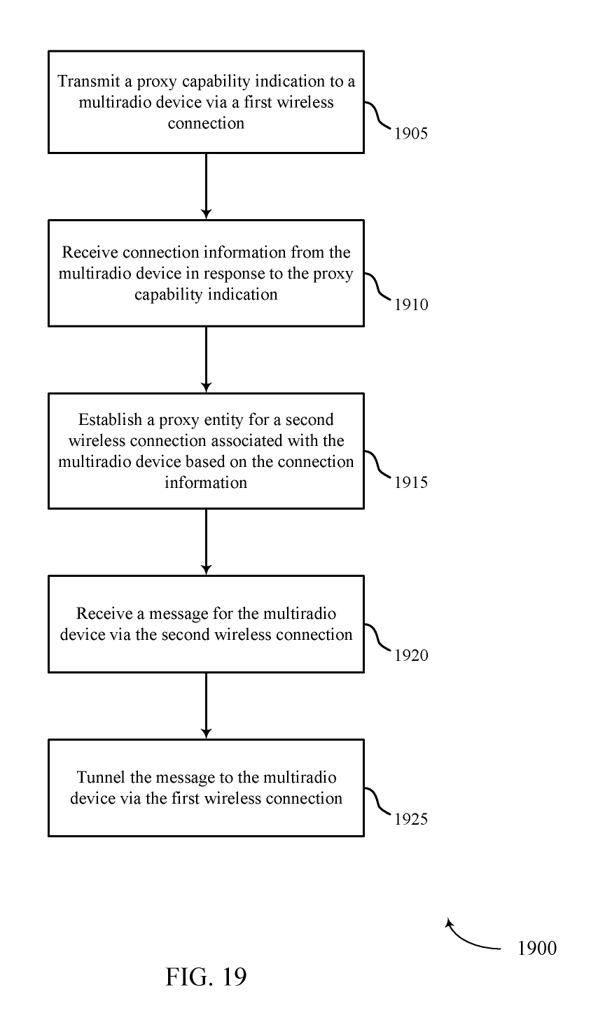

FIG. 19 shows a flowchart illustrating a method 1900 for a multi-radio gateway with wide area network tunneling in accordance with various aspects of the present disclosure. The operations of method 1900 may be implemented by a multi-radio gateway 210 or its components as described with reference to FIGS. 1-12. For example, the operations of method 1900 may be performed by the gateway WAN tunneling component 910 as described with reference to FIGS. 9-12. In some examples, a multi-radio gateway 210 may execute a set of codes to control the functional elements of the multi-radio gateway 210 to perform the functions described below. Additionally or alternatively, the multi-radio gateway 210 may perform aspects of the functions described below using special-purpose hardware. The method 1900 may also incorporate aspects of methods 1300, 1400, 1500, 1600, 1700, and 1800 of FIGS. 13-18.

At block 1905, the multi-radio gateway 210 may transmit a proxy capability indication to a multi-radio device via a first wireless connection as described with reference to FIGS. 2-4. In certain examples, the operations of block 1905 may be performed by the proxy capability indication component 1005 as described with reference to FIG. 10.

At block 1910, the multi-radio gateway 210 may receive connection information from the multi-radio device in response to the proxy capability indication as described with reference to FIGS. 2-4. In certain examples, the operations of block 1910 may be performed by the connection information component 1010 as described with reference to FIG. 10.

At block 1915, the multi-radio gateway 210 may establish a proxy entity for a second wireless connection associated with the multi-radio device based on the connection information as described with reference to FIGS. 2-4. In certain examples, the operations of block 1915 may be performed by the proxy entity component 1015 as described with reference to FIG. 10.

At block 1920, the multi-radio gateway 210 may receive a message for the multi-radio device via the second wireless connection as described with reference to FIGS. 2-4. In certain examples, the operations of block 1920 may be performed by the receiver 905 as described with reference to FIG. 9.

At block 1925, the multi-radio gateway 210 may tunnel the message to the multi-radio device via the first wireless connection as described with reference to FIGS. 2-4. In certain examples, the operations of block 1925 may be performed by the GW tunneling component 1020 as described with reference to FIG. 10.

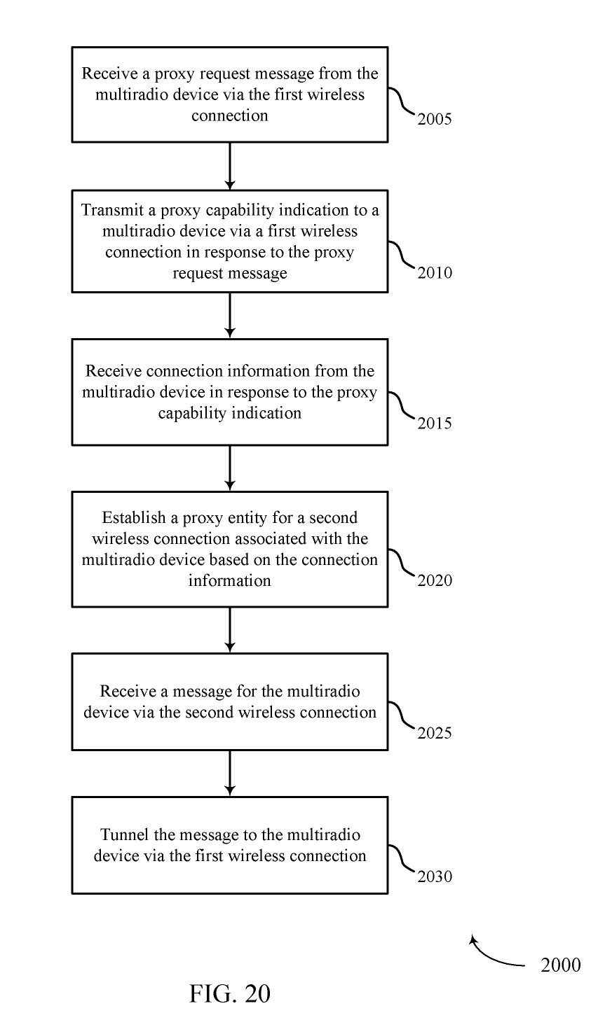

FIG. 20 shows a flowchart illustrating a method 2000 for a multi-radio gateway with wide area network tunneling in accordance with various aspects of the present disclosure. The operations of method 2000 may be implemented by a multi-radio gateway 210 or its components as described with reference to FIGS. 1-12. For example, the operations of method 2000 may be performed by the gateway WAN tunneling component 910 as described with reference to FIGS. 9-12. In some examples, a multi-radio gateway 210 may execute a set of codes to control the functional elements of the multi-radio gateway 210 to perform the functions described below. Additionally or alternatively, the multi-radio gateway 210 may perform aspects of the functions described below using special-purpose hardware. The method 2000 may also incorporate aspects of methods 1300, 1400, 1500, 1600, 1700, 1800, and 1900 of FIGS. 13-19.

At block 2005, the multi-radio gateway 210 may receive a proxy request message from the multi-radio device via the first wireless connection, such that the proxy capability indication is transmitted in response to the proxy request message as described with reference to FIGS. 2-4. In certain examples, the operations of block 2005 may be performed by the GW proxy request component 1105 as described with reference to FIG. 11.

At block 2010, the multi-radio gateway 210 may transmit a proxy capability indication to a multi-radio device via a first wireless connection as described with reference to FIGS. 2-4. In certain examples, the operations of block 2010 may be performed by the proxy capability indication component 1005 as described with reference to FIG. 10.

At block 2015, the multi-radio gateway 210 may receive connection information from the multi-radio device in response to the proxy capability indication as described with reference to FIGS. 2-4. In certain examples, the operations of block 2015 may be performed by the connection information component 1010 as described with reference to FIG. 10.

At block 2020, the multi-radio gateway 210 may establish a proxy entity for a second wireless connection associated with the multi-radio device based on the connection information as described with reference to FIGS. 2-4. In certain examples, the operations of block 2020 may be performed by the proxy entity component 1015 as described with reference to FIG. 10.

At block 2025, the multi-radio gateway 210 may receive a message for the multi-radio device via the second wireless connection as described with reference to FIGS. 2-4. In certain examples, the operations of block 2025 may be performed by the receiver 905 as described with reference to FIG. 9.

At block 2030, the multi-radio gateway 210 may tunnel the message to the multi-radio device via the first wireless connection as described with reference to FIGS. 2-4. In certain examples, the operations of block 2030 may be performed by the GW tunneling component 1020 as described with reference to FIG. 10.

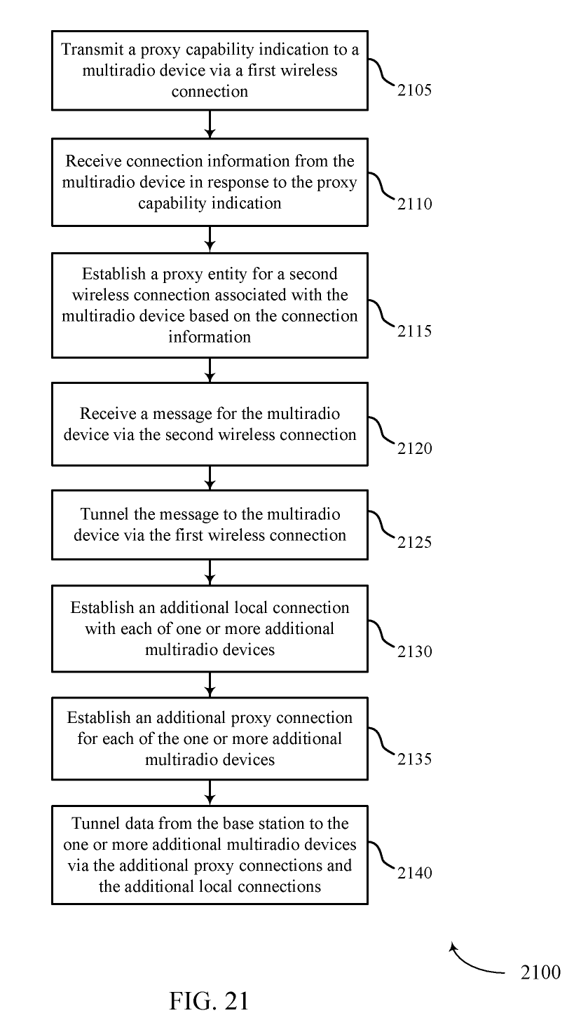

FIG. 21 shows a flowchart illustrating a method 2100 for a multi-radio gateway with wide area network tunneling in accordance with various aspects of the present disclosure. The operations of method 2100 may be implemented by a multi-radio gateway 210 or its components as described with reference to FIGS. 1-12. For example, the operations of method 2100 may be performed by the gateway WAN tunneling component 910 as described with reference to FIGS. 9-12. In some examples, a multi-radio gateway 210 may execute a set of codes to control the functional elements of the multi-radio gateway 210 to perform the functions described below. Additionally or alternatively, the multi-radio gateway 210 may perform aspects of the functions described below using special-purpose hardware. The method 2100 may also incorporate aspects of methods 1300, 1400, 1500, 1600, 1700, 1800, 1900, and 2000 of FIGS. 13-20.

At block 2105, the multi-radio gateway 210 may transmit a proxy capability indication to a multi-radio device via a first wireless connection as described with reference to FIGS. 2-4. In certain examples, the operations of block 2105 may be performed by the proxy capability indication component 1005 as described with reference to FIG. 10.

At block 2110, the multi-radio gateway 210 may receive connection information from the multi-radio device in response to the proxy capability indication as described with reference to FIGS. 2-4. In certain examples, the operations of block 2110 may be performed by the connection information component 1010 as described with reference to FIG. 10.

At block 2115, the multi-radio gateway 210 may establish a proxy entity for a second wireless connection associated with the multi-radio device based on the connection information as described with reference to FIGS. 2-4. In certain examples, the operations of block 2115 may be performed by the proxy entity component 1015 as described with reference to FIG. 10.

At block 2120, the multi-radio gateway 210 may receive a message for the multi-radio device via the second wireless connection as described with reference to FIGS. 2-4. In certain examples, the operations of block 2120 may be performed by the receiver 905 as described with reference to FIG. 9.

At block 2125, the multi-radio gateway 210 may tunnel the message to the multi-radio device via the first wireless connection as described with reference to FIGS. 2-4. In certain examples, the operations of block 2125 may be performed by the GW tunneling component 1020 as described with reference to FIG. 10.

At block 2130, the multi-radio gateway 210 may establish an additional local connection with each of one or more additional multi-radio devices as described with reference to FIGS. 2-4. In certain examples, the operations of block 2130 may be performed by the connection component 605 as described with reference to FIG. 6.

At block 2135, the multi-radio gateway 210 may establish an additional proxy entity for each of the one or more additional multi-radio devices as described with reference to FIGS. 2-4. In certain examples, the operations of block 2135 may be performed by the proxy entity component 1015 as described with reference to FIG. 10.

At block 2140, the multi-radio gateway 210 may tunnel data from the base station to the one or more additional multi-radio devices via the additional proxy entities and the additional local connections as described with reference to FIGS. 2-4. In certain examples, the operations of block 2140 may be performed by the tunneling component 620 as described with reference to FIG. 6.

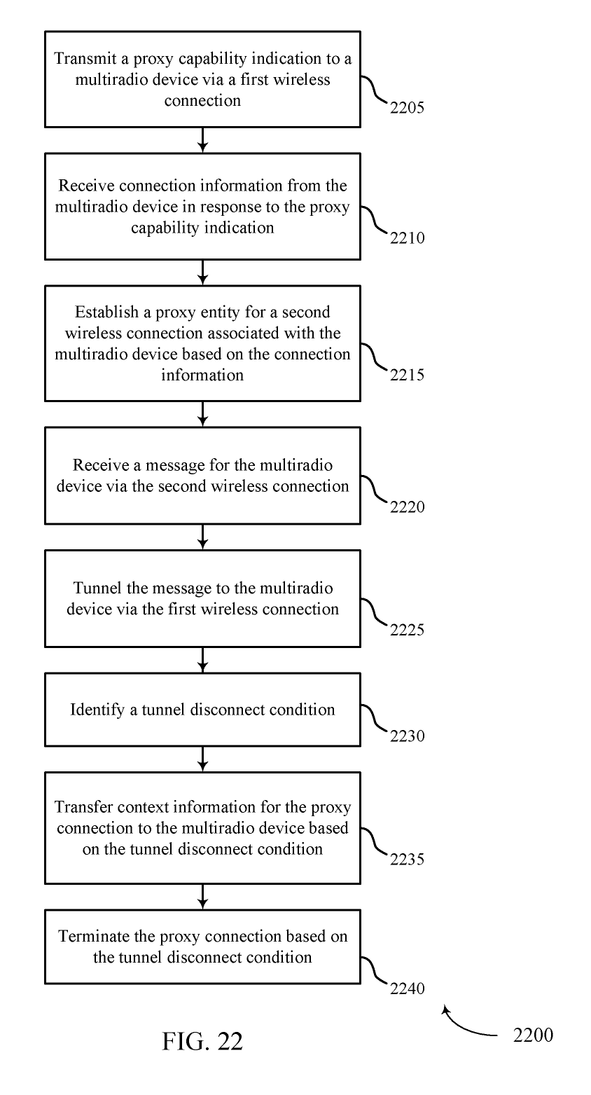

FIG. 22 shows a flowchart illustrating a method 2200 for a multi-radio gateway with wide area network tunneling in accordance with various aspects of the present disclosure. The operations of method 2200 may be implemented by a multi-radio gateway 210 or its components as described with reference to FIGS. 1-12. For example, the operations of method 2200 may be performed by the gateway WAN tunneling component 910 as described with reference to FIGS. 9-12. In some examples, a multi-radio gateway 210 may execute a set of codes to control the functional elements of the multi-radio gateway 210 to perform the functions described below. Additionally or alternatively, the multi-radio gateway 210 may perform aspects of the functions described below using special-purpose hardware. The method 2200 may also incorporate aspects of methods 1300, 1400, 1500, 1600, 1700, 1800, 1900, 2000, and 2100 of FIGS. 13-21.

At block 2205, the multi-radio gateway 210 may transmit a proxy capability indication to a multi-radio device via a first wireless connection as described with reference to FIGS. 2-4. In certain examples, the operations of block 2205 may be performed by the proxy capability indication component 1005 as described with reference to FIG. 10.

At block 2210, the multi-radio gateway 210 may receive connection information from the multi-radio device in response to the proxy capability indication as described with reference to FIGS. 2-4. In certain examples, the operations of block 2210 may be performed by the connection information component 1010 as described with reference to FIG. 10.

At block 2215, the multi-radio gateway 210 may establish a proxy entity for a second wireless connection associated with the multi-radio device based on the connection information as described with reference to FIGS. 2-4. In certain examples, the operations of block 2215 may be performed by the proxy entity component 1015 as described with reference to FIG. 10.

At block 2220, the multi-radio gateway 210 may receive a message for the multi-radio device via the second wireless connection as described with reference to FIGS. 2-4. In certain examples, the operations of block 2220 may be performed by the receiver 905 as described with reference to FIG. 9.

At block 2225, the multi-radio gateway 210 may tunnel the message to the multi-radio device via the first wireless connection as described with reference to FIGS. 2-4. In certain examples, the operations of block 2225 may be performed by the GW tunneling component 1020 as described with reference to FIG. 10.

At block 2230, the multi-radio gateway 210 may identify a tunnel disconnect condition as described with reference to FIGS. 2-4. In certain examples, the operations of block 2230 may be performed by the tunnel termination component 715 as described with reference to FIG. 7.

At block 2235, the multi-radio gateway 210 may transfer context information for the proxy entity to the multi-radio device based on the tunnel disconnect condition as described with reference to FIGS. 2-4. In certain examples, the operations of block 2235 may be performed by the GW connection context component 1125 as described with reference to FIG. 11.

At block 2240, the multi-radio gateway 210 may terminate the proxy entity based on the tunnel disconnect condition as described with reference to FIGS. 2-4. In certain examples, the operations of block 2240 may be performed by the tunnel termination component 715 as described with reference to FIG. 7.

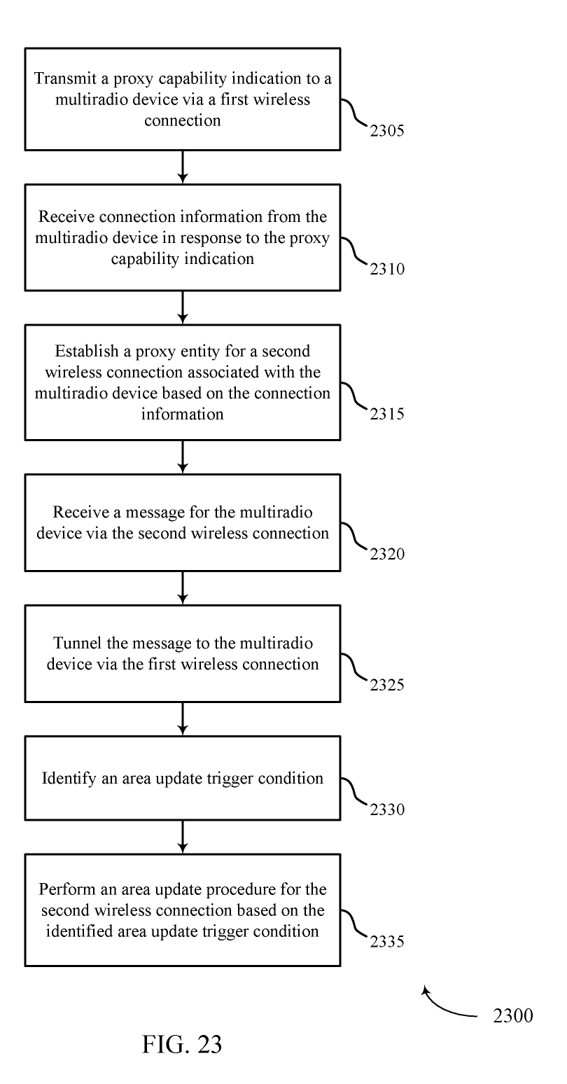

FIG. 23 shows a flowchart illustrating a method 2300 for a multi-radio gateway with wide area network tunneling in accordance with various aspects of the present disclosure. The operations of method 2300 may be implemented by a multi-radio gateway 210 or its components as described with reference to FIGS. 1-12. For example, the operations of method 2300 may be performed by the gateway WAN tunneling component 910 as described with reference to FIGS. 9-12. In some examples, a multi-radio gateway 210 may execute a set of codes to control the functional elements of the multi-radio gateway 210 to perform the functions described below. Additionally or alternatively, the multi-radio gateway 210 may perform aspects of the functions described below using special-purpose hardware. The method 2300 may also incorporate aspects of methods 1300, 1400, 1500, 1600, 1700, 1800, 1900, 2000, 2100, and 2200 of FIGS. 13-22.

At block 2305, the multi-radio gateway 210 may transmit a proxy capability indication to a multi-radio device via a first wireless connection as described with reference to FIGS. 2-4. In certain examples, the operations of block 2305 may be performed by the proxy capability indication component 1005 as described with reference to FIG. 10.

At block 2310, the multi-radio gateway 210 may receive connection information from the multi-radio device in response to the proxy capability indication as described with reference to FIGS. 2-4. In certain examples, the operations of block 2310 may be performed by the connection information component 1010 as described with reference to FIG. 10.

At block 2315, the multi-radio gateway 210 may establish a proxy entity for a second wireless connection associated with the multi-radio device based on the connection information as described with reference to FIGS. 2-4. In certain examples, the operations of block 2315 may be performed by the proxy entity component 1015 as described with reference to FIG. 10.

At block 2320, the multi-radio gateway 210 may receive a message for the multi-radio device via the second wireless connection as described with reference to FIGS. 2-4. In certain examples, the operations of block 2320 may be performed by the receiver 905 as described with reference to FIG. 9.

At block 2325, the multi-radio gateway 210 may tunnel the message to the multi-radio device via the first wireless connection as described with reference to FIGS. 2-4. In certain examples, the operations of block 2325 may be performed by the GW tunneling component 1020 as described with reference to FIG. 10.

At block 2330, the multi-radio gateway 210 may identify an area update trigger condition as described with reference to FIGS. 2-4. In certain examples, the operations of block 2330 may be performed by the GW area update component 1130 as described with reference to FIG. 11.

At block 2335, the multi-radio gateway 210 may perform an area update procedure for the second wireless connection based on the identified area update trigger condition or notify a multi-radio device to reconnect and perform the area update procedure as described with reference to FIGS. 2-4. In certain examples, the operations of block 2335 may be performed by the area update component 730 as described with reference to FIG. 7.

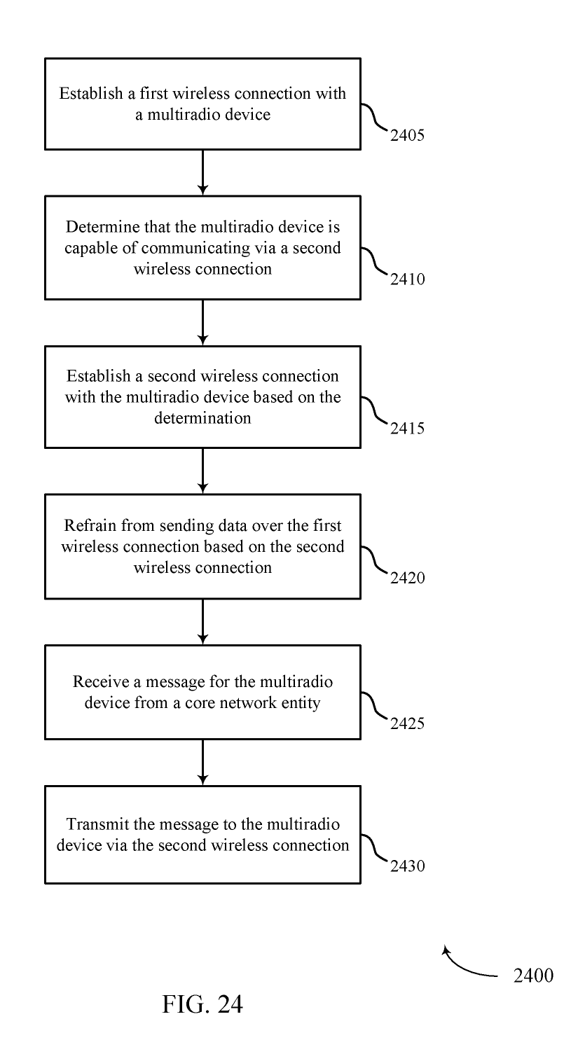

FIG. 24 shows a flowchart illustrating a method 2400 for a multi-radio gateway with wide area network tunneling in accordance with various aspects of the present disclosure. The operations of method 2400 may be implemented by a multi-radio gateway 210 or its components as described with reference to FIGS. 1-12. For example, the operations of method 2400 may be performed by the gateway WAN tunneling component 910 as described with reference to FIGS. 9-12. In some examples, a multi-radio gateway 210 may execute a set of codes to control the functional elements of the multi-radio gateway 210 to perform the functions described below. Additionally or alternatively, the multi-radio gateway 210 may perform aspects of the functions described below using special-purpose hardware. The method 2400 may also incorporate aspects of methods 1300, 1400, 1500, 1600, 1700, 1800, 1900, 2000, 2100, 2200, and 2300 of FIGS. 13-23.

At block 2405, the multi-radio gateway 210 may establish a first wireless connection with a multi-radio device as described with reference to FIGS. 2-4. In certain examples, the operations of block 2405 may be performed by the connection component 605 as described with reference to FIG. 6.

At block 2410, the multi-radio gateway 210 may determine that the multi-radio device is capable of communicating via a second wireless connection as described with reference to FIGS. 2-4. In certain examples, the operations of block 2410 may be performed by the multi-radio detection component 1025 as described with reference to FIG. 10.

At block 2415, the multi-radio gateway 210 may establish a second wireless connection with the multi-radio device based on the determination as described with reference to FIGS. 2-4. In certain examples, the operations of block 2415 may be performed by the connection component 605 as described with reference to FIG. 6.

At block 2420, the multi-radio gateway 210 may refrain from sending data over the first wireless connection based on the second wireless connection as described with reference to FIGS. 2-4. In certain examples, the operations of block 2420 may be performed by the tunneling component 620 as described with reference to FIG. 6.

At block 2425, the multi-radio gateway 210 may receive a message for the multi-radio device from a core network entity as described with reference to FIGS. 2-4. In certain examples, the operations of block 2425 may be performed by the receiver 905 as described with reference to FIG. 9.

At block 2430, the multi-radio gateway 210 may transmit the message to the multi-radio device via the second wireless connection as described with reference to FIGS. 2-4. In certain examples, the operations of block 2430 may be performed by the tunneling component 620 as described with reference to FIG. 6.

Thus, methods 1300, 1400, 1500, 1600, 1700, 1800, 1900, 2000, 2100, 2200, 2300, and 2400 may provide for a multi-radio gateway with wide area network tunneling. It should be noted that methods 1300, 1400, 1500, 1600, 1700, 1800, 1900, 2000, 2100, 2200, 2300, and 2400 describe possible implementation, and that the operations and the steps may be rearranged or otherwise modified such that other implementations are possible. In some examples, aspects from two or more of the methods 1300, 1400, 1500, 1600, 1700, 1800, 1900, 2000, 2100, 2200, 2300, and 2400 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

In LTE/LTE-a networks, including such networks described herein, the term evolved node B (eNB) may be generally used to describe the base stations. The wireless communications system or systems described herein may include a heterogeneous LTE/LTE-a network in which different types of evolved node B (eNBs) provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for frequency division duplex (FDD) (e.g., frame structure type 1) and TDD (e.g., frame structure type 2).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
establishing a first wireless connection with a multi-radio gateway and a second wireless connection with a base station;
receiving a proxy capability indication from the multi-radio gateway;
transmitting connection information to the multi-radio gateway based at least in part on the proxy capability indication, wherein the connection information relates to the second wireless connection;
establishing a tunnel to the base station utilizing a proxy entity within the multi-radio gateway, wherein the proxy entity is capable of communicating with the base station based at least in part on the connection information; and
closing a physical (PHY) connection of the second wireless connection based at least in part on the tunnel.

2. The method of claim 1, further comprising:
receiving data related to the second wireless connection via the tunnel after the data is sent from the base station to the proxy entity of the multi-radio gateway.

3. The method of claim 1, further comprising:
transmitting a proxy request message to the multi-radio gateway, wherein the proxy capability indication is received in response to the proxy request message.

4. The method of claim 1, wherein closing the PHY connection comprises:
powering down at least one component of a radio associated with the second wireless connection.

5. The method of claim 1, wherein the proxy capability indication is received in a beacon message via the first wireless connection.

6. The method of claim 1, wherein the first wireless connection comprises a wireless local area network connection, and the second wireless connection comprises a wide area network connection.

7. The method of claim 1, further comprising:
receiving a paging message from the base station via the tunnel.

8. The method of claim 7, further comprising:
terminating the tunnel based at least in part on the paging message.

9. The method of claim 7, further comprising:
reestablishing the PHY connection based at least in part on the paging message.

10. The method of claim 7, wherein the paging message is received in a beacon via the first wireless connection.

11. The method of claim 7, wherein the paging message is received in a vendor specific action frame with prioritized interframe space (PIFS) access.

12. The method of claim 1, further comprising:
receiving a message from the multi-radio gateway, wherein the message is a broadcast or multicast message from the base station.

13. The method of claim 12, wherein the message is received in a DTIM broadcast or multicast message via the first wireless connection.

14. The method of claim 12, wherein the message is received in a unicast packet via the first wireless connection.

15. The method of claim 1, further comprising:
receiving context information for the second wireless connection from the multi-radio gateway;
closing the tunnel based at least in part on the received context information; and
resuming the PHY connection based at least in part on the received context information.

16. The method of claim 15, further comprising:
transmitting a tunnel disconnect message to the multi-radio gateway, wherein the context information is received in response to the tunnel disconnect message.

17. The method of claim 15, further comprising:
performing an abbreviated timing alignment procedure based at least in part on the context information, wherein resuming the PHY connection is based at least in part on the abbreviated timing alignment procedure.

18. The method of claim 15, wherein the context information is received based at least in part on a multi-radio gateway initiated disconnect procedure.

19. The method of claim 1, further comprising:
reestablishing the second wireless connection with a second base station; and
performing an area update procedure based at least in part on the reestablished second wireless connection.

20. The method of claim 19, further comprising:
determining that the proxy entity is disabled;
identifying a cell that the proxy entity is camped on; and
performing a cell selection procedure for the identified cell based at least in part on the determination that the proxy entity is disabled.

21. The method of claim 19, further comprising:
receiving a reconnection request for the second wireless connection from the multi-radio gateway, wherein reestablishing the second wireless connection and performing the area update procedure are based at least in part on the reconnection request.

22. The method of claim 19, further comprising:
moving to a location outside a region of the base station; and
receiving one or more connection parameters from the multi-radio gateway based at least in part on moving to the location, wherein reestablishing the second wireless connection and performing the area update procedure are based at least in part on the one or more connection parameters.

23. The method of claim 22, wherein the region of the base station comprises a tracking area, a location area, or a routing area of the base station.

24. The method of claim 19, further comprising:
moving to a location outside a basic service set (BSS) associated with an AP the multi-radio gateway; and
performing a cell acquisition procedure for the second base station based at least in part on moving to the location.

25. A method of wireless communication, comprising:
establishing a first wireless connection with a multi-radio gateway;
receiving an indication that the multi-radio gateway is capable of communicating via a second wireless connection, wherein the second wireless connection consumes less power than the first wireless connection;
establishing the second wireless connection with the multi-radio gateway based at least in part on the indication;
closing a PHY connection of the first wireless connection based at least in part on the second wireless connection; and
receiving a message from the multi-radio gateway via the second wireless connection.

26. The method of claim 25, wherein the first wireless connection comprises a wide area network connection and the second wireless connection comprises a local area network connection.

27. The method of claim 25, further comprising:
entering an idle mode for the first wireless connection, wherein establishing the second wireless connection is based at least in part on entering the idle mode.

28. The method of claim 25, wherein the message is a paging message, a control message, a broadcast message, or a multicast message; and
the method further comprising reopening the PHY connection based at least in part on the message.

29. A method of wireless communication, comprising:
transmitting a proxy capability indication to a multi-radio device via a first wireless connection;
receiving connection information from the multi-radio device in response to the proxy capability indication;
establishing a proxy entity for a second wireless connection associated with the multi-radio device based at least in part on the connection information;
receiving a message for the multi-radio device via the second wireless connection; and
tunneling the message to the multi-radio device via the first wireless connection.

30. A method of wireless communication, comprising:
establishing a first wireless connection with a multi-radio device;
determining that the multi-radio device is capable of communicating via a second wireless connection;
establishing the second wireless connection with the multi-radio device based at least in part on the determination;
refraining from sending data over the first wireless connection based at least in part on the second wireless connection;
receiving a message for the multi-radio device from a core network entity; and
transmitting the message to the multi-radio device via the second wireless connection.
